(19) United States
(12) Patent Application Publication
(10) Pub. No.: US 2026/0301071 A1
(43) Pub. Date: Oct. 1, 2026

(54) METHODS AND SYSTEMS OF FACILITATING STOCK VALUATION

(71) Applicant: Eric Georges Soenen, Austin, TX (US)

(72) Inventor: Eric Georges Soenen, Austin, TX (US)

(21) Appl. No.: 19/550,010

(22) Filed: Feb. 25, 2026

Related U.S. Application Data
(60) Provisional application No. 63/779,994, filed on Mar. 28, 2025.

(51) Int. Cl. G06Q 40/04

(52) U.S. Cl. CPC G06Q 40/042

(57) ABSTRACT

The present disclosure provides a method of facilitating stock valuation. Further, the method includes receiving a company data from a user device associated with a user. Further, the method includes obtaining a financial statement of the company based on the company data. Further, the method includes extracting a financial metric of the company from the financial statement. Further, the method includes generating a stock fair value data based on the financial metric. Further, the stock fair value data includes an estimated fair value of a stock of the company. Further, the method includes obtaining a stock data. Further, the stock data includes an actual price value of the stock of the company. Further, the method may include generating a valuation ratio data based on the stock fair value data and the stock data. Further, the method includes transmitting the valuation ratio data to the user device.

### FIELD OF DISCLOSURE

The present disclosure relates to the field of data processing. More specifically, the present disclosure relates to methods and systems of facilitating stock valuation and of making this valuation interactive.

### BACKGROUND

The present disclosure relates generally to the field of computer-implemented financial analysis and digital educational technologies, particularly those used for evaluating the financial performance of publicly traded companies and teaching users the principles of stock valuation. The field is of considerable importance as financial literacy, investment analysis, and data-driven decision-making increasingly rely on sophisticated computational tools capable of processing large volumes of financial information. With the global expansion of retail investing, algorithmic trading, and digital financial education platforms, reliable systems that assist users in understanding and analyzing financial statements, valuations, and market dynamics have become essential.

A fundamental objective in the field is to provide accurate, accessible, and comprehensible analyses of company performance and stock value so that users—whether novice learners or experienced analysts—may make informed decisions and deepen their understanding of financial concepts. Achieving the objective requires systems capable of translating complex financial data into meaningful insights while handling the inherent variability and uncertainty present in real-world financial metrics.

Existing systems that attempt to support financial analysis or valuation-related education encounter numerous limitations that hinder the ability to achieve the objective effectively. Many available tools rely on rigid analytical models that do not sufficiently reflect the dynamic nature of real-world financial behavior, creating discrepancies between projected company performance and market outcomes. Some existing systems employ oversimplified valuation techniques that lack the flexibility to adapt to varying financial structures, growth conditions, or industry environments, thereby reducing the reliability of the results. Other platforms struggle to present financial information in a manner that is intuitive or educationally effective, limiting user engagement and preventing meaningful exploration of how different financial assumptions influence valuation outcomes. Additional challenges arise from the difficulty of managing data variability, addressing large fluctuations in growth patterns, and calibrating analytic models across heterogeneous sets of companies while maintaining computational stability and performance.

The above deficiencies may result in inaccurate insights, diminished educational impact, and reduced trust in valuation assessments, ultimately impeding the ability of users to learn effectively or to evaluate companies with confidence.

Therefore, there is a need for improved methods and systems of facilitating stock valuation that may overcome one or more of the preceding problems.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of facilitating stock valuation. Further, the method may include receiving, using a communication device, one or more company data from one or more user devices associated with one or more users. Further, the one or more company data indicate one or more companies to perform the stock valuation. Further, the method may include obtaining, using a processing device, one or more financial statements of the one or more companies from one or more first external sources based on the one or more company data. Further, the method may include extracting, using the processing device, one or more financial metrics of the one or more companies from the one or more financial statements. Further, the method may include generating, using the processing device, a stock fair value data based on the one or more financial metrics. Further, the stock fair value data includes an estimated fair value of one or more stocks of the one or more companies. Further, the method may include obtaining, using the processing device, a stock data from one or more second external sources. Further, the stock data includes an actual price value of the one or more stocks of the one or more companies. Further, the method may include generating, using the processing device, a valuation ratio data based on the stock fair value data and the stock data. Further, the valuation ratio data includes a valuation ratio of the one or more stocks. Further, the method may include transmitting, using the communication device, the valuation ratio data to the one or more user devices.

The present disclosure provides a system for facilitating stock valuation. Further, the system may include a communication device. Further, the communication device may be configured for receiving one or more company data from one or more user devices associated with one or more users. Further, the one or more company data indicate one or more companies to perform the stock valuation. Further, the communication device may be configured for transmitting a valuation ratio data to the one or more user devices. Further, the system may include a processing device communicatively coupled with the communication device. Further, the processing device may be configured for obtaining one or more financial statements of the one or more companies from one or more first external sources based on the one or more company data. Further, the processing device may be configured for extracting one or more financial metrics of the one or more companies from the one or more financial statements. Further, the processing device may be configured for generating a stock fair value data based on the one or more financial metrics. Further, the stock fair value data includes an estimated fair value of one or more stocks of the one or more companies. Further, the processing device may be configured for obtaining a stock data from one or more second external sources. Further, the stock data includes an actual price value of the one or more stocks of the one or more companies. Further, the processing device may be configured for generating the valuation ratio data based on the stock fair value data and the stock data. Further, the valuation ratio data includes a valuation ratio of the one or more stocks.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3A illustrates a flowchart of a method 300 of facilitating stock valuation, in accordance with some embodiments.

FIG. 3B illustrates a continuation of the flowchart of the method 300 of facilitating stock valuation, in accordance with some embodiments.

FIG. 4 illustrates a flowchart of a method 400 of facilitating stock valuation including obtaining, using the processing device 904, a share data of the at least one company from the at least one second external source, in accordance with some embodiments.

FIG. 5 illustrates a flowchart of a method 500 of facilitating stock valuation including obtaining, using the processing device 904, at least one updated financial metric, in accordance with some embodiments.

FIG. 6 illustrates a flowchart of a method 600 of facilitating stock valuation including adjusting, using the processing device 904, at least one model parameter, in accordance with some embodiments.

FIG. 7 illustrates a flowchart of a method 700 of facilitating stock valuation including computing, using the processing device 904, a plurality of logarithmic valuation ratios of the plurality of stocks using the plurality of valuation ratios, in accordance with some embodiments.

FIG. 8 illustrates a flowchart of a method 800 of facilitating stock valuation including generating, using the processing device 904, a Screener Figure of Metric (SFOM) data of the at least one stock, in accordance with some embodiments.

FIG. 9 illustrates a block diagram of a system 900 of facilitating stock valuation, in accordance with some embodiments.

FIG. 10 illustrates a flowchart of a method 1000 of facilitating stock valuation including generating, using the processing device 904, a suggestion data, in accordance with some embodiments.

FIG. 11 illustrates a flowchart of a method 1100 of facilitating stock valuation including generating, using the processing device 904, an additional financial data, in accordance with some embodiments.

FIG. 12 illustrates a flowchart of a method 1200 of facilitating stock valuation including generating, using the processing device 904, a valuation table data, in accordance with some embodiments.

FIG. 13 illustrates a flowchart of a method 1300 of facilitating stock valuation including generating, using the processing device 904, a risk metric of the valuation ratio, in accordance with some embodiments.

FIG. 14 illustrates a flowchart of a method 1400 of facilitating stock valuation including generating, using the processing device 904, a stock valuation data of the at least one stock, in accordance with some embodiments.

FIG. 15 illustrates a flowchart of a method 1500 of facilitating stock valuation including generating, using the processing device 904, a graphical data, in accordance with some embodiments.

FIG. 16 illustrates a flowchart of a method 1600 of facilitating stock valuation including identifying, using the processing device 904, at least one industry-specific event from the plurality of industry-specific market data, in accordance with some embodiments.

FIG. 17 illustrates a flowchart of a method 1700 of generating an estimated fair value of a share associated with a company, in accordance with some embodiments.

FIG. 18 illustrates a flowchart of a method 1800 of generating an estimated fair value of a share associated with a company including retrieving, using the storage device 2004, a total share quantity data corresponding to a numerical quantity associated with a total number of outstanding shares, in accordance with some embodiments.

FIG. 19 illustrates a flowchart of a method 1900 of generating an estimated fair value of a share associated with a company including generating, using the processing device 2006, a valuation ratio data corresponding to a ratio of each of the estimated fair value and the actual share price, in accordance with some embodiments.

FIG. 20 illustrates a block diagram of a system 2000 for generating an estimated fair value of a share associated with a company, in accordance with some embodiments.

FIG. 21 illustrates a bar graph 2100 representing a constant-growth assumption, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IOT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview:

The present disclosure describes a method of valuing a company. Such a method is also called a “valuation model” because the disclosed method estimates the fair value of a stock based on a combination of inputs. Some of the inputs may be related to the past financial performance of the company, some to the market in general, and some may be based on estimates of future financial performance. The model may be translated into an algorithm, which describes the sequence of calculations needed to evaluate the model (and obtain the fair value estimate).

In some embodiments, the present disclosure describes an interactive app for teaching users about finance and about stock valuation. In some embodiments, the present disclosure describes an interactive website teaching users about finance and about stock valuation.

In some embodiments, the present disclosure describes the following objectives:
1. A parametrizable valuation model that establishes a “fair value” for the stock of publicly traded companies, or privately traded companies for which financial reports are available.
2. The model may use information from the company's financial reports to determine assets and recent earnings, and to estimate future earnings. Based on the assets, the recent earnings, and the future earnings, a value is assigned to the stock of the companies.
3. The model may be “calibrated” or “trained”, so the model may estimate as many stock prices as possible, as accurately as possible.
4. Training is done by varying common parameters within the model, using a pre-determined algorithm, to find a combination where the collective error between the estimates and the actual stock prices, over many stocks, is minimized.

In some embodiments, the present disclosure may facilitate the following workflow:
1. The valuation model calculates a value for a company by taking the sum of:
   The Net Tangible Assets (i.e., Total Assets minus Total Liabilities and Goodwill (Intangible Assets).
   The discounted value of future earnings during a fixed time period (the “time horizon”).
   The discounted value of the “terminal earnings”, at the end of the time horizon, is multiplied by a fixed multiple.
2. The parameters of the model may include the discount rate (typically 7% to 8% per year), the number of years used for the time horizon (typically 5 to 10 years), and the multiplier for the terminal earnings (typically 5 to 20).
3. The Estimated Fair Value (EFV) of the stock (value of one company share) may then be calculated by dividing the total company value by the total number of outstanding shares. The EFV is sometimes also called “V-Guess” (VGSS).

In some embodiments, the disclosed method may include the following steps:
A. Selection, Download, and Data Extraction
   1. Select a set of companies to analyze.
   The selection may be based on user input, a previously saved watch list, or a pre-determined list of similar stocks (e.g., companies in the same industry).
   2. Download the financial statements for the companies in that set, particularly the Income Statement and Balance Sheet.
   3. Extract relevant information (key metrics) from the financial statements.
   Some metrics are well-known and commonly used (like Profit Margin or Price/Earnings ratio); others may be unique to the disclosed method, especially the ones used by the valuation model.
   The extraction of the metrics may involve heuristics, data filtering, interpolation, and extrapolation.
   Important metrics that are used by the valuation model are (a) Baseline Quarterly Revenue, (b) Yearly Revenue Growth, (c) Cost of Revenue as a percentage of Revenue, and (d) Indirect Costs (i.e., other costs) as a percentage of Revenue.
B. Valuation
   1. Use the valuation model to estimate the fair value of each stock in the set. As mentioned above, the value of the whole company may typically be calculated first, and then divided by the total number of outstanding shares.
   2. Compare the Estimated Fair Value (EFV) to the actual stock price. The comparison may be done by taking the ratio of the EFV to the actual stock price. The ratio may be called the Valuation Ratio.
      A ratio>1 implies that the stock is undervalued (market price lower than estimated fair value).
      A ratio<1 implies that the stock is overvalued (market price higher than estimated fair value).
C. Display
   1. Display the ratios on demand for the selected set of companies, so the financial strength of the companies may be compared. In addition to the valuation ratio, other financial metrics may be typically displayed in the same table.
   2. Provide additional visualization tools to accompany the display of the valuation ratios, showing things like the income statement and graphs of revenue and earnings over time. The purpose is to allow the user to relate valuation measures to financial data.
D. Stock Screener and Screener Figure of Merit
   1. A traditional screener orders a list of stocks by a particular metric. The list of stock facilities compares stocks based on different metrics (compare along different dimensions).
   2. The disclosed method, an improved screener, allows a user to define a custom Screener Figure of Merit (SFOM), which is a weighted average of several key values.
   The SFOM may include the Fair Value Estimate defined above.
   3. Ordering a list of stocks by SFOM facilitates comparing the stocks' “desirability”, where desirability is defined by the user, through the SFOM.
E. Interactive Valuation
   1. The app (or website) has a feature that allows a user to manually override some of the metrics used in the valuation model. Normally, the metrics may be derived from the financial statements, using built-in heuristics.
   2. The default metrics may be replaced by values based on individual studies, the use of the graphical tools provided by the app, or insights provided by third-party analysts.
   3. Interactively observing how the values calculated by the valuation model change is a powerful learning tool. The interactive valuation shows exactly how a change in assumptions changes the valuation of a stock.
F. Model Training
   1. The model may be trained by valuating a predetermined set of bellwether stocks, and varying the model parameters so that overall, the valuations get as close to the actual stock prices as possible. (A variety of methods may be used to vary the parameters and find the optimal solution as efficiently as possible.)
   2. The model training may not be intended as a user feature, but is done periodically by the manager of the app or website. However, enabling model training on demand, as an additional feature, would be possible.

In some embodiments, the present disclosure describes an app: The app or website is structured in pages, which may be accessed as follows:
1. A home page, allowing a user to select a set of companies (stocks) by entering the company name one by one. In an embodiment, the companies are referred to by the company's ticker symbols, but referral by the full company name would be possible, too.
2. Alternatively, companies may be chosen from a previously saved list, or from a default list where companies are organized in categories like activity or type of industry (e.g., car manufacturers, semiconductor, airlines, . . . )
3. An overview page, showing a table with the names of the companies in the set, the valuation ratios, and some other key financial parameters. In an embodiment, VRAT refers to the valuation ratio (ratio of estimated value to actual stock price). VSIG is the sigma (standard deviation) on the VRAT estimate, AVGR is the average revenue growth, PROF is the Profit Margin (Net Income to Revenue Ratio), NIPR is the Net Income to Price Ratio (the “return” on the stock), and PERT is the Price to Earnings Ratio (inverse of NIPR).
4. A page specific to one company (selected by clicking the appropriate link in the previous menu), showing several additional menu options.
5. Additional pages, which may be called from the Company page, show additional detail (graphs, calculations, etc.) for each company.
6. A page for overriding the default values for key parameters like revenue growth, cost of revenue percentage, and profit percentage, which are used to calculate the valuation. Overriding the values causes the valuation to be recalculated on the spot.

Valuing a company means estimating a “Fair Value” for the company. The resulting estimate is called the company valuation. When the company is owned by shareholders, the Fair Value of one common share of stock (the “stock price”) may be determined by dividing the Fair Value of the company by the number of outstanding shares. So, valuing the stock is essentially equivalent to valuing the whole company. Determining the valuation is not an exact science and involves assumptions, which often require judgment. Many methods have been proposed, each with its own pros and cons.

A method of valuing a company is also called a “valuation model” because the method estimates the fair value of a stock based on a combination of inputs. Some of the inputs are related to the past financial performance of the company, some to the market in general, and some are based on estimates of future financial performance. The model may be translated into an algorithm, which describes the sequence of calculations needed to evaluate the model. The purpose of valuation is to determine a fair value at the time of the valuation, based on sound financial principles. Valuation may not directly aim to predict the future price of a stock, even though one might argue that undervalued stocks (actual price lower than fair value) might be more likely to increase in value than overvalued stocks (price higher than fair value).

In some embodiments, the performance of a model is determined by how well the model predicts the current price of many stocks in the market. One might argue that the “ideal” model would predict every price of every stock in the market perfectly. Of course, that is not realistic. Such a model might be excessively complex, as the model might need to be highly customized to every type of stock. Such a model would also have limited use. If the user simply wanted to know the market price of a stock, the user would just get a quote. Much more useful would be an “almost perfect” model. If the user could predict the price of almost every stock accurately, but the user found one stock that was undervalued, the user could theoretically buy that one stock based on the assumption that the stock was priced incorrectly with respect to the rest of the market and would soon revert to the stock's “ideal” price (go up in price).

Further, there is a need for a valuation model that estimates the fair value of a wide range of stocks so that overall, they all match the market well. But at the same time, the model must be simple enough to be practical and must provide insight into what contributes to the value of each stock. A key benefit of a good valuation model is to provide a tool for users to learn about the financial performance of a wide range of potentially very different companies. The disclosed method is not just an investment tool, but an educational tool. For the above purpose, a valuation model must be intuitive.

Some valuation models may be based on the comparison of key financial metrics with other companies, often companies in the same field as the company being valued. A very simple example is valuation based on Price to Earnings Ratio (P/E ratio). The value of the company is assumed to be the product of its yearly earnings by a fixed factor, the target P/E ratio, which is determined by studying the P/E ratios of comparable companies. Another example uses the Price-to-Sales Ratio (P/S ratio) instead of the P/E ratio. The use of the P/S ratio is fairly common for companies that are not yet profitable and have negative earnings. Other methods may be based on anticipated future returns for an investor buying the stock. The more sophisticated methods (the ones that do more than simply comparing metrics) rely on assumptions about future financial performance. But because assumptions are based on judgment, different models may not yield a unique result.

One of the most respected techniques in financial circles is called “Discounted Cash Flow”, or DCF. The DCF may be based on predictions of future cash flows (the difference between money entering the company and money leaving the company), which are discounted to the present and summed together. The discount rate is an important concept in finance. The discount rate is an “interest rate” of sorts, which is applied to future cash receipts or outlays to calculate an equivalent present value. DCF typically uses a two-stage model. For a number of years (the first stage), individual cash flows are discounted and added up. After the first stage, there is an assumption that cash flows may grow at a constant rate forever (perpetual growth model). The following is how the second stage is handled. As long as the growth rate is less than the assumed discount rate, the contributions add up to a finite number, which is added to the contributions from the first stage. One of the challenges of the DCF method is to come up with a meaningful Discount Rate, since the whole valuation is so dependent on the Discount Rate. Quite common to adjust the Discount Rate depending on the industry a certain company is in, which, of course, makes the Discount Rate less universal.

In some embodiments, the proposed model calculates the Fair Value of a Company as the sum of Net Tangible Assets (NTAS), Discounted Earnings (DEAR), and Discounted Terminal Value of Earnings (DTVE). The reasoning is straightforward and intuitive. Users simply assume that users buy (stock in) a company today and resell the stock after a number of years, NYRS. The fair value of the user investment today, consists of the present value of the Equity (Assets minus Liabilities, corrected for intangibles like Goodwill), plus the Net Present Value of the earnings while the user owns the stock (discounted to today), plus the price the user may get for the additional future earnings when the user sells the stock after NYRS (also discounted to today). The price the user may get after NYRS is assumed to be equal to the (yearly) earnings at that point in time, multiplied by a fixed P/E factor, which is predetermined and is assumed to be independent of whether revenues or profits keep growing or not.

The disclosed model differs from the DCF in the following ways:
1. The model uses 3 components, as opposed to 2 stages in the DCF model.
2. The model uses earnings instead of Cash Flow.
3. The model does not use a perpetual growth model but assumes that the company (or stock) may be sold at a fixed Price to Earnings (P/E) ratio at a predetermined point in the future.

In some embodiments, the disclosed model may perform the following detailed calculations:
1. Net Tangible Assets (NTAS): The calculation is straightforward. Total Assets (TASS), minus Goodwill (GWIL), minus Total Liabilities (TLIA). The numbers come straight out of the company's balance sheet.
2. Discounted Earnings, estimated by extrapolating Total Revenue and cost numbers. Two types of cost are considered: (1) Cost of Revenue and (2) Indirect Costs, which are all other costs.
Earnings are the difference between (1) Total Revenue, and (2) Cost of Revenue and Indirect Cost.
Three key values are used to determine each for the fair value calculation. Each one is derived from the company's financials (Income Statement).
   Average Growth Rate of Total Revenue (AVGR)
   Average Ratio of Cost of Revenue to Total Revenue (CRAV)
   Average Ratio of Indirect Costs to Total Revenue (ICAV)
Like in the DCF model, the user assumes an initial stage, which lasts NYRS years and during which the user considers individual quarterly earnings, followed by a terminal stage in which the user considers a single, lumped value for all remaining earnings.
   Total Revenue is extrapolated over time by assuming a constant growth rate, AVGR, each period. (The user considers revenue by quarter.) AVGR is typically expressed in % per year but may easily be converted to a quarterly value.
   Cost of Revenue is extrapolated assuming that the Cost of Revenue grows at the same rate as Total Revenue, which implies that the ratio of Cost of Revenue to Total Revenue remains constant and equal to CRAV.
   Indirect Cost is extrapolated assuming that the Indirect Cost grows at a rate slightly slower than Cost of Revenue (which grows at a rate AVGR).
The slower growth rate (SLGR) is calculated so that after NYRS, the Indirect Cost has only grown as if the original growth rate (AVGR) had been maintained for (NYRS-DLAY) years. DLAY is a “delay” of sorts, which conveniently captures the difference in growth rates.
SLGR may be calculated from AVGR as follows:

$$SLGR = ( 1 + \$AVGR ) ** ( ( \$NYRS - \$DLAY ) / \$NYRS ) - 1 )$$

The dual-growth approach is unique to the valuation model. It is a powerful feature, as the dual-growth approach accurately represents what happens in the case of early-stage companies, which start off losing money but grow fast and eventually break even and become profitable.
DLAY is one of the model parameters that is adjusted when “training” the model, as may be described later.
3. Discounted Terminal Value of Earnings, calculated by taking the (extrapolated) earnings for the period right after the first stage, multiplying the earnings by a constant factor (the Terminal Multiplier, TMLT), and discounting earnings back to the present.
The factor TMLT is fixed and determined experimentally, not based on theoretical considerations, like maintaining a certain growth rate forever (in the case of DCF).

Further, some companies, typically start-ups, go through a phase of extreme growth, where the yearly Revenue Growth may reach 20%, 30%, or even higher (even 100% is not unheard of). Such high growth poses some problems for company valuation, as the initial growth rate is typically not sustainable for more than a few years. Using the high growth rates directly could confuse the valuation algorithm and could create wildly optimistic numbers. There are cases where the extremely high growth was sustained, like for Tesla (TSLA) or Nvidia (NVDA), but these cases were unusual. For the other (majority of) cases, the extreme growth problem is addressed by running the growth number (positive or negative) through a so-called “sigmoid” (or S-shape) function. The sigmoid function may not affect values close to 0 (small or moderate growth) much, while large values are gradually limited, so the values do not exceed a predetermined value. The sigmoid function limit, or maximum growth rate, is one of the parameters that may be adjusted in the proposed model, called GLIM (growth limit).

In some embodiments, the valuation model may use more parameters. For example, instead of simply using the Net Tangible Assets (NTAS) of a company to calculate the estimated fair value, either NTAS or the components that make up NTAS (Total Assets or TASS, Total Liabilities or TLIA, and Goodwill or GWIL) may be multiplied by an adjustable factor. For example, in the model, NTAS may be replaced by (TASS * TAFC-GWIL * GWFC-TLIA * TLFC). In the above example, the adjustable factors TAFC, GWFC, and TLFC are model parameters that may be adjusted to get a better fit of the model to the market. The resulting model is more complex because it uses 8 parameters instead of 5, but the resulting model would be able to better reflect the fact that stock prices don't always fully price in the value of assets and liabilities.

In some embodiments, the calculated fair values may not be a convenient measure to compare multiple stocks, as the calculated fair values reflect the absolute stock price. And stock prices may vary over a wide range from company to company, regardless of the actual quality in terms of company earnings and assets. A better measure to evaluate and compare stocks is the ratio of Fair Value to the actual stock price. The valuation ratio may be called as V-Ratio. The V-ratio (VRAT) is obtained by dividing the estimated Fair Value of a stock (V-Guess or VGSS) by the last available stock price (LAST).

$$VRAT = VGSS / LAST$$

The V-Ratio facilitates comparing the valuations of vastly different companies, using a measure that is independent of company size. A VRAT greater than 1 implies that, based on the underlying business fundamentals, the stock is worth more than what the stock is currently priced at, which might be an incentive to buy. A VRAT smaller than 1 implies that the stock is worth less than what the stock is currently priced at, which could be an incentive to sell.

Model training:
a) Purpose
   Another word for “training” is “fitting”. The model training consists of choosing appropriate values for the adjustable parameters of the valuation model, so the best possible performance is obtained over a wide range of conditions. Note that the model parameters are ideally the same for any company. The model is not trained for individual companies or small subsets of companies.
   One aim of the proposed valuation model is to be unified. One model, with one set of parameters, may be used for any company (or any stock), within a wide range of industries, market caps, and stock prices.
b) Model Parameters
   The following parameters may be adjusted within the proposed model.
      Discount rate (DISC)
      Time horizon (NYRS)
      Time delay (DLAY)
      Terminal multiplier (TMLT)
      The growth limit (GLIM)
c) Training the Model
   It may be impractical to fit the model to all publicly traded stocks every time. There are too many (well over 3,000 just in the US alone). Some of the stocks are very obscure. Others have spotty, irregular, or even incorrect financial reports.
   Instead, the model may be trained using a representative subset, or sample, of a few tens to a few hundreds of stocks. The stocks in the sample serve as “bellwethers” for the other stocks, which are not in the sample. (A bellwether serves as an indicator or predictor of trends or developments. The term originated from the practice of placing a bell on the lead sheep of a flock to help guide the others.)
d) Sample Selection
   To get broad coverage, training should not rely on a single type of stock to train the model, but a representative mix of stocks with different characteristics. Training may be sourced from several categories, similar to the categories identified by many financial advisors.
   Sample stocks may be classified along two axes.
      By market capitalization:
         Small cap
         Mid-cap
         Large cap
      By growth:
         Growth stocks
         Value stocks
   To train the model, 6 sets may be created based on the combinations of categories above, and put a similar number of stocks in each set, by ensuring that there is a good fit for each set, plus a good fit when the 6 sets are combined into one larger one.
e) Fitting Figure of Merit
   The mathematically inclined may recognize the fitting as an optimization problem. The trendier ones would call the fitting an AI problem, since the model is trained using real-world data sets.
   AI and Deep Learning are based on the above type of training algorithm, often using massive optimization. Each optimization problem needs a Fitting Figure of Merit, or FFOM. The FFOM tells how good the optimization is, how good the model is. “Good” means that the model may accurately predict the price of each stock that the model analyzes. Of course, no matter how much the model is optimized, the model may never predict the price of each stock perfectly, but the FFOM has to come as close as possible, for as many stocks as possible.
   The FFOM is the combination of all the differences between the value the model predicts and the actual stock price, for each stock in the set. A perfect model would have an FFOM of 0, since there would be no difference.
   To make sure the FFOM is always positive, the differences may be squared, or their absolute value may be computed, before summing the results.
f) V-Ratio and Logarithm
   To make things work more predictably, a few additional tweaks are made to the definition of the FFOM. For the fitting, the ratio of VGSS to the actual stock price: VRAT may be used. The VRAT facilitates comparing stocks with a low share price to stocks with a high share price fairly.
   Using VRAT directly was found to create a bias toward lower values. To avoid the bias toward lower values, the model uses the base-2 logarithm (LOG2) of VRAT rather than VRAT itself. When VRAT is 2, the logarithm is 1. When VRAT is 1/2, the logarithm is −1. When VRAT is 1 (perfect prediction, with VGSS equal to the actual stock price), the logarithm is 0. The model uses the absolute value of the logarithm, as the training is based on a sum of positive numbers. (The training may be based on a square value instead, but the absolute value was found to work well).
g) Fitting Procedure
Conceptually, fitting the model is fairly straightforward.
   Vary the parameters DISC, NYRS, DLAY, TMLT, and GLIM. Each combination is called an iteration.
   Go through every stock in the set.
   Calculate the LOG2 of VRAT for each stock.
   Sum all the absolute values of each LOG2 together for each iteration.
   Keep iterating (trying new combinations of DISC, NYRS, YMLT, TMLT, and DLAY).
   Try to get the sum (or average) of all the absolute values of LOG2s as close to 0 as possible. The iteration with the smallest sum represents the best fit.
Varying the 5 parameters randomly for hundreds of stocks is not very efficient. Because so many parameter combinations are possible, finding a reasonable fit (reasonably small sum) for a large sample of stocks may take some time.
Through the use of more sophisticated search algorithms, the fitting may be done more efficiently, requiring fewer computing resources. But even a brute-force approach, where every combination is tried, may effectively be run in a few hours, on an average home personal computer.

In some embodiments, the disclosed system is configured to minimize a sum of positive values for all stocks in a given sample to achieve an optimal model fit. Further, the positive values may be defined as the absolute value or the squared difference between each stock value and a corresponding market price.

In some embodiments, the model fitting may be performed using one or more measures of deviation, including:
1. The difference between the estimated stock price and the actual stock price.
2. The ratio of the estimated stock price to the actual price [VRAT].
3. The logarithm of VRAT.

Further, even though any of the said measures may be used to perform the fitting, the logarithm of VRAT has been found to yield superior results.

In some embodiments, the model may make the following assumptions:
4. Total Revenue grows at a constant rate (AVGR).
5. Cost of Revenue grows at the same constant rate (the ratio to Total Revenue, CRAV, is constant).
6. Indirect Costs grow at a slower rate than the Cost of Revenue.
7. Growth may stop at the end of the time horizon, and value may be based on P/E only.

### Justification for the Growth Assumption:

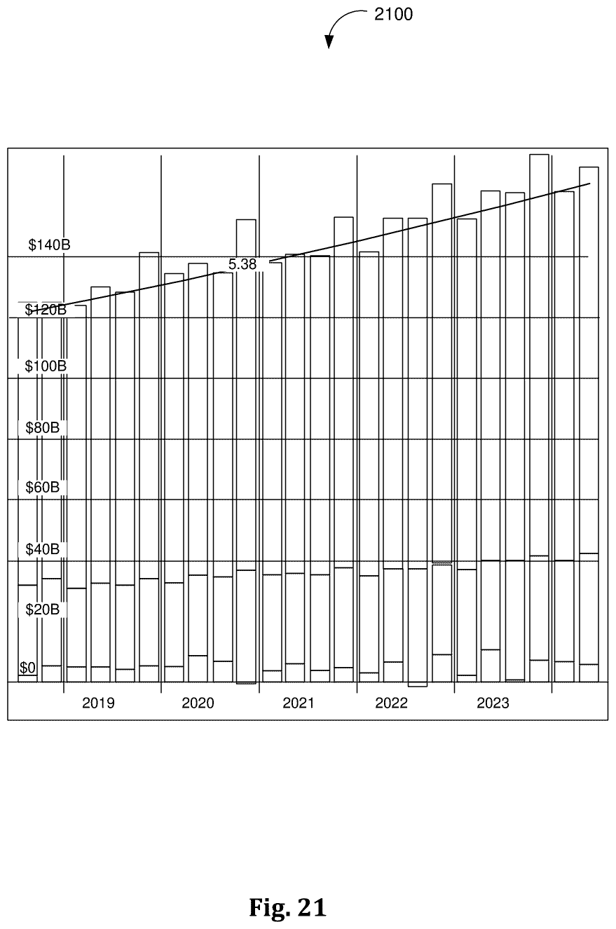

Three assumptions are made to calculate the growth rate in the model:
1. Constant-growth assumption of Total Revenue, true for “established” companies, which have a predictable financial track record. FIG. 21 is an example for Walmart (Ticker: WMT).
2. Constant Cost of Revenue ratio assumption.
3. Dual-growth assumption holds particularly well for start-up companies that start off losing money but grow revenues faster than indirect costs.

### Finite Growth Assumption:

After a certain time, the company's revenue stops growing (when the user sells the user's stocks predetermined P/E ratio). Until that time, the user assumes that revenue growth is constant, which means that Total Revenue grows exponentially. Is that realistic? Other valuation models tend to assume the growth tapers off more gradually over time, and Total Revenue exhibits more of an S-shape. Experiments were performed using both assumptions and the results. The results did not find a significant improvement in model performance using the “gradual” assumption instead of the “exponential” assumption. Therefore, using the exponential assumption is comfortable.

Further, in the strict sense of financial theory, any valuation should be based on anticipated future cash flows: the receipt or spending of cash, discounted back to the present. That is why the Discounted Cash Flow method (DCF) is often considered the standard.

The proposed model does not use Cash Flow. Instead, the proposed model uses Company Earnings. And using earnings simplifies the calculations greatly.
Over time, cash flow and earnings tend to even out. Using accrual accounting, expenses get spread out over time (like the useful life of an asset) and earnings (revenues minus expenses) reflect that.
For large companies, not common to have large cash inflows or expenditures at specific times. Cash comes in and flows out gradually. Therefore, earnings and cash flow tend to be very close when considered over a longer period, like a quarter or a year.
In the end, Cash Flow projections are not an exact science anyway. Just like earnings, the cash flow projections have to be estimated, and estimates for future Cash Flow are typically quite close to estimates for future earnings.

Further, a fundamental concept in finance is “risk”. Risk is related to uncertainty, which, using statistical techniques, may be quantified in terms of standard deviation, or sigma. The present disclosure defines VSIG as the standard deviation, or sigma, on VRAT. VSIG represents the uncertainty on VRAT, or the uncertainty associated with the valuation. Companies with very predictable earnings have a low VSIG. Examples are Apple (AAPL), Walmart (WMT), Ferrari (RACE), etc. One could argue that VSIG is a good indication of the risk associated with buying the stock of a company. A higher VSIG indicates uncertainty about the future earnings and the valuation.

A key principle of finance is that higher-risk investments typically demand a higher return. That is typically reflected in VRAT and VSIG. On average, companies with a low VSIG (predictable earnings) tend to have a lower VRAT. That lower VRAT is typically associated with a higher Price to Earnings (P/E) ratio. Another way to interpret is that companies with predictable earnings (low VSIG) tend to be rewarded by the market. The companies with predictable earnings (low VSIG) often trade at a lower VRAT, which actually means that the stocks are traded at a premium (higher stock price).

Calculating VSIG through an exact formula would be extremely difficult. Fortunately, statistics provides tools to approximate sigma quite accurately, relying on simple calculations. The theory states that if there is a function of several independent variables, the sigma of the function may be approximated based on the sigma of the variables. That is the case of VRAT. VRAT is a function of many variables. Key variables, which are estimated as part of the proposed valuation methodology, are (1) the estimated Average Revenue Growth, AVGR, (2) the estimated Cost of Revenue Ratio (CRAV), and (3) the estimated Net Income Before Tax Ratio (NIAV).

The theory says that the standard deviation of the function (VRAT) may be approximated using the following Steps:
Compute the partial derivatives of the function with respect to each variable.
Evaluate the derivatives at the expected values of the variables (the averages).
Multiply each derivative by the corresponding variable's standard deviation.
Combine the contributions in an RMS (Root Mean Square) sense: square, sum, and take the square root of the sum.
The formula below summarizes the above steps:

$${σ}_{f} \approx \sqrt{{( \frac{\partial f}{\partial {x}_{1}} {σ}_{{x}_{i}} )}^{2} + {( \frac{\partial f}{\partial {x}_{2}} {σ}_{{x}_{2}} )}^{2} + … + {( \frac{\partial f}{\partial {x}_{n}} {σ}_{{x}_{n}} )}^{2}} .$$

The above formula is called as “Propagation of Uncertainty” formula.

Because the disclosed model estimates the values of AVGR, CRAV, and NIAV by considering growth and profitability values over several quarters, the model has multiple data points for each value. The model may easily estimate the standard deviation of each, using standard statistical methods.

The last remaining challenge is to derive the partial derivatives of VRAT with respect to AVGR, CRAV, and IBAV. Fortunately, there is a numerical solution for that as well. Partial derivatives may be approximated very accurately by evaluating a function (VRAT) for the nominal values of the variables (AVGR, CRAV, and IBAV) and then evaluating the function again, with a very small variation in one of the variables. The partial derivative in that one variable is then simply the ratio of the variation in the value of the function to the variation that was applied to that one variable. An added advantage of having a model that depends on a limited set of well-defined variables is that the sensitivity to each variable may be easily computed.

In some embodiments, the proposed model uses a fixed discount rate, DISC, to relate future earnings and the terminal value of earnings back to the present. The value of the discount rate is determined through model fitting at certain times. In principle, DISC may vary each time fitting is performed, but the DISC is typically between 7% and 8% a year, which is very consistent with the discount rate other models (like DCF) assume, often based on theoretical considerations. Using a fixed value for DISC, a valuation ratio, VRAT, may be calculated for a set of stocks. Because the proposed model is calibrated to be unbiased, some stocks may typically have a VRAT higher than 1, while others have a VRAT lower than 1.

An interesting exercise the model allows is to vary the discount rate from the original assumption and try to find a different rate, which causes the VRAT to be exactly 1, called the “implied Discount Rate”, or IDSC. A simple way to calculate IDSC is to vary the discount rate from a low or negative value (say, −50% a year) to a high value (say, 50% a year) in constant steps, and look for a value that causes VRAT to be close to 1. IDSC may provide additional insights into a company or the company's stock. In finance, higher uncertainty often dictates a higher return or a steeper discount for an investment. IDSC quantifies that discount. The stocks of very stable, solid companies with predictable earnings have IDSC values below the market rate (DISC), sometimes even 0 or negative values. Stocks of newer, fast-growing, or more unpredictable companies tend to have much higher IDSC values, sometimes up to 50% a year.

Further, the studies using real financial data of hundreds of randomly selected companies have shown that the assumptions within the proposed model are justified. The result in Fair Value predictions of stock prices is very much in line with the actual market prices. The extensive experiments, using sizable data sets (hundreds of stocks at a time), were conducted to try to get the best possible fit.

The analysis may be performed by varying the parameters (DISC, NYRS, DLAY, TMLT, GLIM) over wide ranges, and observing the behavior of the model. As a measure of the model quality (fit) for each set of parameters, the logarithm base 2 (log 2) of the VRAT of each stock (called LOG2) may be calculated. For each set of parameters, the arithmetic average of each LOG2, as well as the RMS (Root Mean Square) average of each LOG2, may be calculated. A set of parameters may be picked for which the average LOG2 was 0 (meaning that the average VRAT was 1). That meant that the model was “centered”, or “unbiased”.

For the same combination of parameters, an RMS average of about 0.7 was observed. That was about the lowest RMS value of all the runs, and meant that in an RMS sense, the VRAT estimates were typically within a factor of 1.62 (2\hat{ }0.7) of the ideal value of 1 (between 0.62 and 1.62). Given the wide range of stocks that are analyzed, and the fact that some stocks are obviously much more volatile (higher standard deviation, or VSIG) than others, the results are quite acceptable.

In some embodiments, the present disclosure describes a method of valuing a company, or its stock, using a model that calculates the sum of (1) its Net Tangible Assets at the present time, (2) its estimated earnings between the present and a predetermined time in the future (the time horizon), discounted back to the present, and (3) a Terminal Value based on its anticipated earnings right after the time horizon, multiplied by a fixed terminal multiplier and discounted back to the present.

Further, future earnings are estimated by assuming a constant growth rate for Total Revenue, a constant growth rate for Cost of Revenue, and a different growth rate for Indirect Costs.

Further, the growth rate of Total Revenue is assumed to be constant and is estimated based on the growth rate of Total Revenue in recent financial reporting periods.

Further, the ratio of Cost of Revenue to Total Revenue is assumed to be constant and is estimated based on that ratio in recent financial reporting periods.

Further, the ratio of Indirect Cost to Total Revenue is estimated based on that ratio in recent financial reporting periods.

Further, in some embodiments, the present disclosure describes a method of quantifying the uncertainty on the valuation, by estimating the standard variation (sigma) of that valuation based on estimates for the standard variations of total revenue growth, cost of revenue ratio, and indirect cost ratio, and on the sensitivities of the valuation to variations on these.

Further, in some embodiments, the present disclosure describes a method of quantifying the implied discount rate of the valuation by varying the discount rate while keeping all other model parameters constant, until the valuation is approximately equal to the market cap or stock price.

Further, in some embodiments, the present disclosure describes a method of training the model so the model predicts the value of multiple companies in a predetermined set as accurately as possible, using a Fitting Figure of Merit based on the proximity of the valuation of each company to its corresponding actual stock price, by varying a number of adjustable parameters in the model, which are common to each company in the set.

Further, in some embodiments, the present disclosure describes an interactive computer means where a user may modify the disclosed assumptions and observe the effect on the estimated future financial performance and on the valuation of a company.

Further, in some embodiments, the present disclosure describes an interactive computer means where a user may modify the model parameters and observe the effect on the valuation of one or more companies.

The following is a simplified calculation, using the syntax of the Perl programming language as an example. In Perl, variable names start with ‘$’. Comment lines start with ‘#’. The V-Ratio (VRAT) is derived from the Fair Value estimate for the company by dividing the Fair Value estimate by the Market Cap, MCAP. MCAP is the product of Share Price and Number of Outstanding Shares. In the algorithm below, the model calculates VRAT using values for Assets and Revenues that have also been scaled by MCAP, called “per price ratios”, as totals are related to share prices. In other words, we divide the different values from the financial reports by $MCAP before summing them, as opposed to afterwards.

Values Derived from Company Financials

```
    $NTPR: Net Tangible Assets to Price Ratio (last quarter)
    $TAPR: Total Assets to Price Ratio (last quarter)
    $TLPR: Total Liabilities to Price Ratio (last quarter)
    $GWPR: Goodwill to Price Ratio (last quarter)
    $TRPR: Total Revenue to Price Ratio (total of last 4 quarters)
    $ESGR: Estimated Growth rate (before sigmoid limit)
    $AVGR: Average Growth rate (after sigmoid limit)
    Model Parameters
    $DISC: Discount rate
    $NYRS: Number of years for growth phase
    $DLAY: Delay parameter used to calculate SLGR from AVGR
    $TMLT: Terminal Multiplier
    $GLIM: Growth Limit
    Intermediate Variables
    $SLGR: Slow Growth
    $GR1: Quarterly rate of growth for $AVGR
    $GR2: Quarterly rate of growth for $SLGR
    $TR: Total Revenue
    $CR: Cost of Revenue
    $IC: Indirect Cost
    $DS: Discount factor
    Outputs:
    $NTPR: Net Tangible Assets to Price Ratio
    $DEPR: Discounted Earnings to Price Ratio
    $DTPR: Discounted Terminal Earnings to Price Ratio
    $EVPR: Earnings Value to Price Ratio
    $VRAT: V-Ratio, or Ratio of Fair Value to Market Price
  # (1) Assets
    $NTPR=$TAPR−$TLPR−$GWPR;
  # (2) Discounted Value of Earnings
    $AVGR=exp_limit($ESGR,$GLIM);
    $SLGR=(1+$AVGR)**(($NYRS−$DLAY)/$NYRS)−1;
    $GR1=(1+$AVGR)**(1/4)−1; # Quarterly rate of growth for $AVGR
    $GR2=(1+$SLGR)**(1/4)−1; # Quarterly rate of growth for $SLGR
    $DS1=(1+$DISC)**(1/4)−1; # Quarterly discount rate
  # Extrapolate TRPR (Total Revenue over Price Ratio, based on last 4 quarters), to get an
estimate of next quarter revenue.
  # Divide yearly revenue by 4 and grow forward by 2.5 quarters.
    $QRPR=$TRPR/4*(1+$GR1) **2.5;
  # Running products
```

| | |
|---|---|
| $TR=$QRPR; | # Total Revenue (per quarter) |
| $CR=$QRPR*$CRAV; | # Cost of Revenue (per quarter) |
| $IC=$QRPR*$ICAV; | # Indirect Costs (per quarter) |
| $DS=1; | # Discount factor (for that quarter) |

```
  # Discounted quarterly earnings
    $DEPR=0;
    $QEARN=(1−$TXAV) *($TR−$CR−$IC)/$DS;
```

| | |
|---|---|
| for ($i=0; $i<($NYRS*4);$i++) | # Step through each quarter of next NYRS years |

```
      {
      # Add running sum for each quarter
      $DEPR+=$QEARN;
      $TR*=(1+$GR1);
      $CR*=(1+$GR1);
      $IC*=(1+$GR2);
      $DS*=(1+$DS1);
      $QEARN=(1−$TXAV)*($TR−$CR−$IC)/$DS;
      }
    }
  # (3) Discounted Terminal Value of Earnings
  # Calculate terminal value based on last quarter * 4
  $DTPR=$QEARN*$TMLT*4;
  # Earnings value to price ratio
  $EVPR=$DEPR+$DTPR;
  # Total
  $VRAT=$NTPR+$EVPR;
```

The present disclosure describes computer-implemented means and methods for teaching finance and performing stock valuation based on a parametrizable valuation engine. The system introduces a plurality of technical features that inherently improve the functioning of valuation algorithms, financial-analysis computation engines, data-extraction subsystems, educational visualization systems, and predictive calibration frameworks.

In some embodiments, the method may be based on an adaptive dual-growth extrapolation engine configured to estimate future earnings by differentiating the growth trajectory of revenue from the growth trajectory of indirect costs. The adaptive dual-growth extrapolation engine improves the technology of algorithmic financial forecasting by replacing the linear and uniform growth assumptions found in prior valuation systems with a dynamic two-rate model that reacts to the empirical financial structures of early-stage and growth-stage companies. The technical problem addressed by the adaptive dual-growth extrapolation engine concerns the inability of prior forecasting engines to manage asymmetrical cost growth patterns characteristic of companies transitioning from loss-making to profit-generating phases. Prior models assume a single constant growth rate, which results in significant compounding error and distortion of valuation outcomes.

In operation, the adaptive dual-growth extrapolation engine may perform extrapolation of Total Revenue using an average revenue-growth rate, while Indirect Costs may grow at a slower rate determined by a delay parameter that numerically compresses the growth trajectory into a reduced effective period. The delay parameter may be computed using an exponential-scale transformation so that the slower growth retains proportionality to overall revenue expansion without introducing instability.

In some embodiments, the engine may compute the slow-growth value using SLGR=(1+AVGR)\hat{ }((NYRS−DLAY)/NYRS)−1, thereby implementing a differentiable delay-modulated exponential growth operator. In other embodiments, alternative approaches such as spline-based dynamic growth curves, probabilistic Bayesian shrinkage of cost-growth variance, or recurrent-network estimators may be employed. The techniques may be applied by a financial-modeling processor to accurately reproduce real-world cost behavior for high-growth or early-stage issuers. The above feature improves the technology of financial-simulation systems by enabling more accurate non-linear modeling without requiring deep-learning engines or large training sets.

In some embodiments, the system may include a sigmoid-based growth limiter applied to revenue-growth metrics to ensure numerical stability during valuation. The sigmoid-based growth limiter improves the technology of stochastic smoothing in financial computation engines, addressing the technical problem that extreme quarterly or yearly growth rates destabilize discounted-earning projections and introduce overflow, divergence, or unrealistic long-term value estimations.

By passing raw growth estimates through a continuous S-shaped function, the system may limit unsustainably large values while preserving precision around moderate or low growth. In some embodiments, the sigmoid may be a logistic curve, hyperbolic tangent, or generalized error-function curve. In further embodiments, the limit may be automatically adjusted based on industry-specific volatility indices, permitting adaptive constraint modulation. The above feature improves the functioning of valuation models by enabling smooth asymptotic stability in the growth dimension, eliminating computational explosions in discounted-value loops, improving convergence behavior, and harmonizing multi-company model training.

In some embodiments, the method may be based on a logarithmic-ratio optimization framework configured to calibrate model parameters across large sets of bellwether stocks. Whereas conventional calibration uses raw error subtraction, the present disclosure employs the base-2 logarithm of the valuation ratio and, in some embodiments, applies absolute transformations to eliminate directional bias. The above feature improves the technology of numerical optimization for financial models, addressing the technical problem that direct comparison of predicted price to actual price produces gradient instability when companies have widely different stock prices. The logarithmic transformation may normalize error contributions, enabling a uniform optimization landscape suitable for iterative parameter search.

In some embodiments, the calibration engine may perform random parameter sampling, simulated annealing, evolutionary optimization, gradient-free search, or multi-objective RMS/mean-error minimization across discount rate, delay parameter, time horizon, growth limit, and terminal multiplier. The calibration engine improves parameter-training performance, convergence speed, and robustness against noisy financial inputs.

In some embodiments, the system may implement an uncertainty-propagation module configured to derive a quantitative measure of variance associated with each stock valuation. The uncertainty-propagation module improves the technology of statistical error-propagation engines by enabling precise sigma computation for multi-variable valuation outputs. The technical problem addressed is that conventional valuation products may not accurately estimate statistical uncertainty for complex financial functions dependent on multiple correlated metrics.

In some embodiments, the method may numerically approximate partial derivatives of valuation with respect to AVGR, CRAV, NIAV, and other contributing variables by computing micro-perturbations in isolated dimensions. The system may then combine them using root-mean-square aggregation to generate a standard-deviation proxy. The result may represent a mathematically rigorous and computationally efficient risk quantifier, improving predictive fidelity and user understanding.

In some embodiments, a real-time valuation engine may be configured to recalculate earnings, discounted projections, terminal value, and valuation ratios in immediate response to user overrides of revenue growth, cost ratios, profitability, discount rates, or terminal multipliers. The real-time valuation engine improves the technology of interactive financial-simulation systems, addressing the technical problem of slow or delayed re-computation that prevents users from exploring financial relationships for educational purposes.

In some embodiments, the system may perform incremental recalculation, where only affected sub-expressions of the valuation model are recomputed. In other embodiments, the system may use GPU-accelerated matrix pipelines or cached intermediate revenue projections for microsecond-level responsiveness. The incremental recalculation feature produces significant improvements in user-facing financial-education technology by providing intuitive, instantaneous learning feedback.

In some embodiments, the system may include a module for automatically adjusting the discount rate based on volatility clusters extracted from historical revenue variance, VSIG outputs, or industry-wide macro-volatility metrics. The system improves the technology of risk-sensitive discounting engines. The technical problem addressed is that fixed discount rates fail to reflect real-time variations in uncertainty. The module may compute implied volatility surfaces or apply exponential smoothing of revenue deviation patterns, generating a dynamic discount parameter. The automatic adjustment of the discount rate makes discounted-earnings projections more robust.

In some embodiments, the system may include a growth estimator that assigns a higher weight to recent quarters using an exponential-decay kernel, Kalman filter, or Bayesian updating model. Further, the system improves the technology of financial-time-series inference engines by solving the problem of models that treat old and recent data equally.

The system may update the AVGR metric using confidence values derived from revenue variance, macro-economic indicators, or sectoral momentum. The system yields more responsive and realistic projections for companies undergoing acceleration or slowdown.

In some embodiments, the system may include a visualization engine capable of generating multi-resolution graphs of earnings, revenue, margins, cost structures, and valuation-ratio trajectories. The technical problem addressed is that conventional financial dashboards do not visualize sensitivity relationships between user-manipulated parameters and valuation outcomes. The system may compute real-time derivative heat maps showing how VRAT changes with respect to AVGR, CRAV, TMLT, or DLAY. In other embodiments, the system may generate motion-based animations illustrating valuation movement over time under different hypothetical assumption profiles. The system improves financial education visualization technology.

In some embodiments, a hybrid terminal-value predictor may be introduced wherein deterministic P/E-based terminal valuation is blended with a stochastic noise model derived from sectoral dispersion of comparable companies. The hybrid terminal-value predictor improves the technology of terminal-value forecasting systems. The technical problem addressed is that deterministic terminal valuation assumes future stability, whereas markets exhibit structural volatility.

In some embodiments, Monte-Carlo sampling of terminal earnings may be performed to generate confidence intervals around the terminal multiplier. In other embodiments, a probabilistic Bayesian terminal-value band may be constructed.

In some embodiments, the system may implement a benchmark-selector that automatically chooses calibration stocks based on liquidity filters, stable reporting histories, cross-industry representativeness, and variance-minimizing coverage. The system improves the technology of training-data selection for financial models. The technical problem addressed is that manual selection of bellwether stocks introduces bias and inconsistency. The automated engine may cluster stocks using unsupervised learning, ensuring evenly distributed samples across growth/value and market-cap axes.

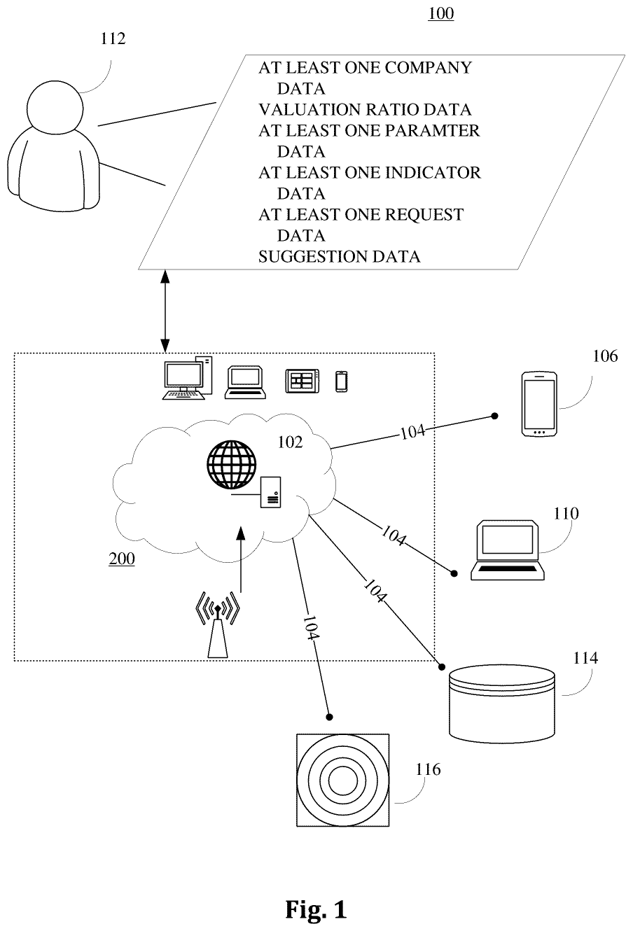

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

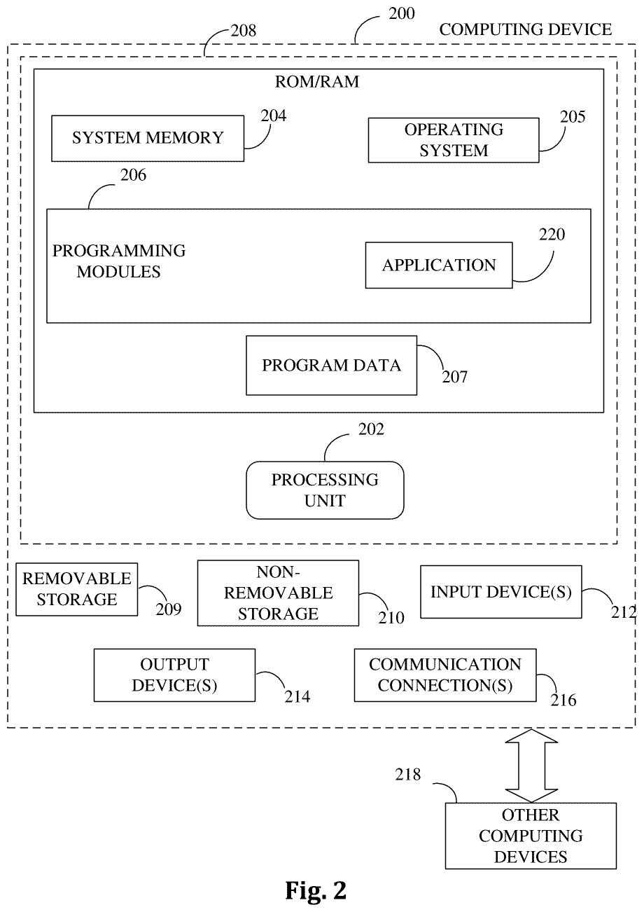

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

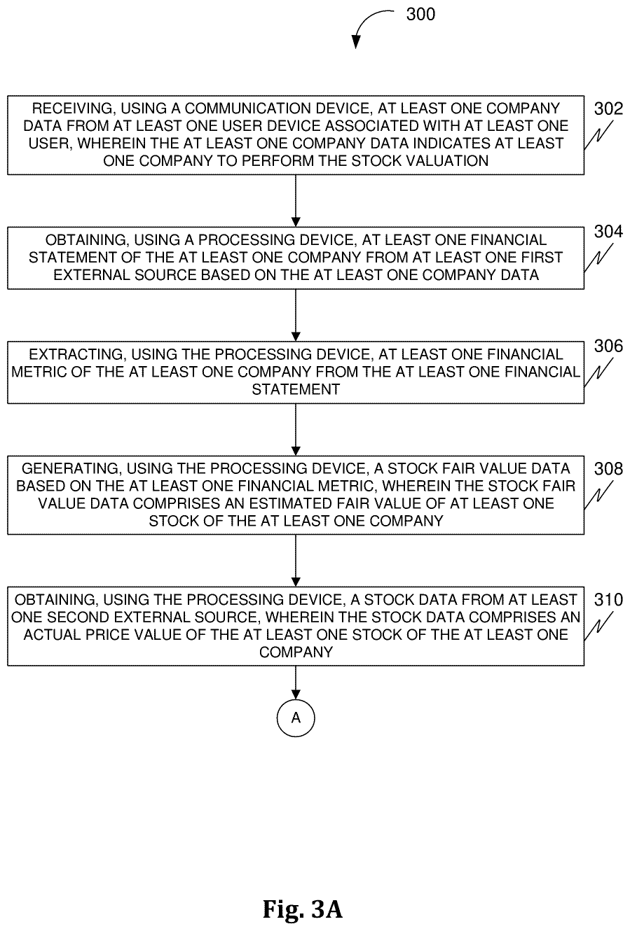

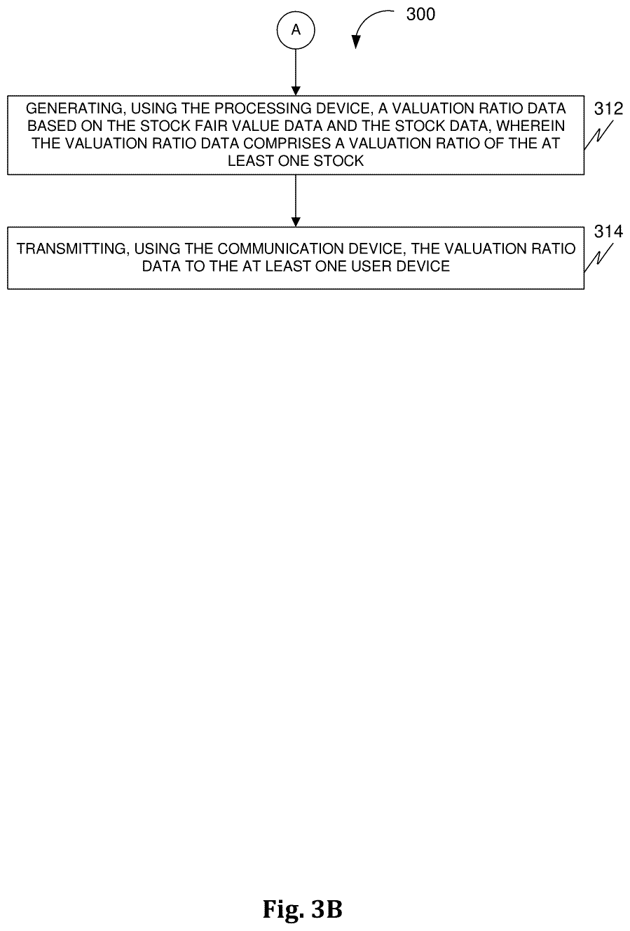

FIG. 3A and FIG. 3B illustrate a flowchart of a method 300 of facilitating stock valuation, in accordance with some embodiments. Further, the method 300 may include a step 302 of receiving, using a communication device 902, one or more company data from one or more user devices associated with one or more users. Further, the one or more company data indicate one or more companies to perform the stock valuation. Further, the method 300 may include a step 304 of obtaining, using a processing device 904, one or more financial statements of the one or more companies from one or more first external sources based on the one or more company data. Further, the method 300 may include a step 306 of extracting, using the processing device 904, one or more financial metrics of the one or more companies from the one or more financial statements. Further, the method 300 may include a step 308 of generating, using the processing device 904, a stock fair value data based on the one or more financial metrics. Further, the stock fair value data includes an estimated fair value of one or more stocks of the one or more companies. Further, the method 300 may include a step 310 of obtaining, using the processing device 904, a stock data from one or more second external sources. Further, the stock data includes an actual price value of the one or more stocks of the one or more companies. Further, the method 300 may include a step 312 of generating, using the processing device 904, a valuation ratio data based on the stock fair value data and the stock data. Further, the valuation ratio data includes a valuation ratio of the one or more stocks. Further, the method 300 may include a step 314 of transmitting, using the communication device 902, the valuation ratio data to the one or more user devices.

In some embodiments, the one or more financial metrics may include one or more of a price-to-earnings ratio and a growth rate. Further, the extracting of the one or more financial metrics may include estimating the one or more financial metrics based on the one or more financial statements. Further, the estimating of the one or more financial metrics may include one or more of interpolation and extrapolation of the one or more financial metrics.

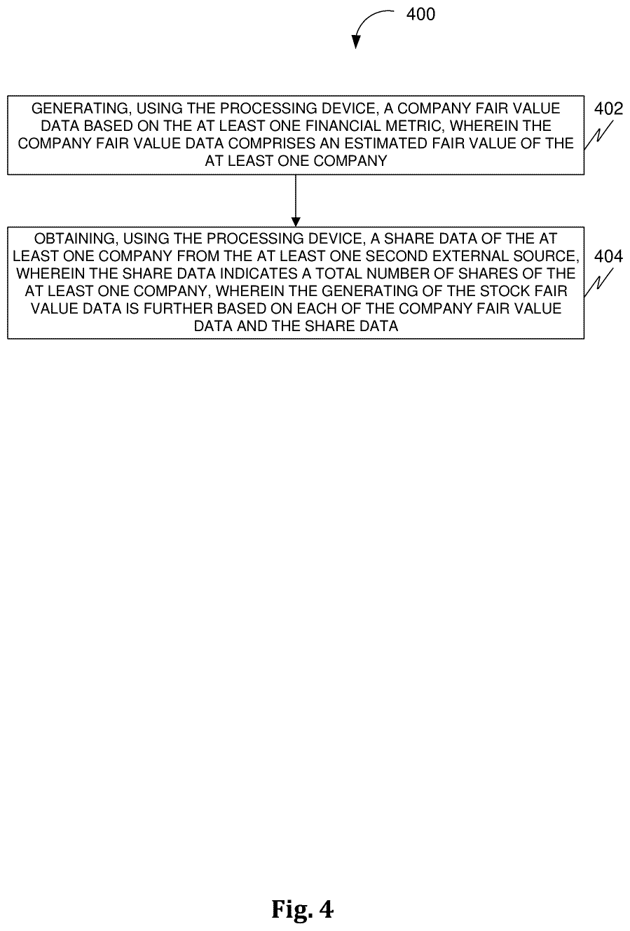

FIG. 4 illustrates a flowchart of a method 400 of facilitating stock valuation including obtaining, using the processing device 904, a share data of the at least one company from the at least one second external source, in accordance with some embodiments. Further, in some embodiments, the method 400 further may include a step 402 of generating, using the processing device 904, a company fair value data based on the one or more financial metrics. Further, the company fair value data includes an estimated fair value of the one or more companies. Further, in some embodiments, the method 400 further may include a step 404 of obtaining, using the processing device 904, a share data of the one or more companies from the one or more second external sources. Further, the share data indicates a total number of shares of the one or more companies. Further, the generating of the stock fair value data may be further based on each of the company fair value data and the share data.

In some embodiments, the extracting of the one or more financial metrics may include extracting one or more asset metrics of the one or more companies based on the one or more financial statements. Further, the extracting of the one or more financial metrics may include extracting one or more present earning metrics of the one or more companies based on the one or more financial statements. Further, the extracting of the one or more financial metrics may include estimating one or more future earning metrics of the one or more companies based on the one or more financial statements. Further, the generating of the company fair value data may be based on the extracting of the one or more asset metrics, the extracting of the one or more present earning metrics, and the estimating of the one or more future earning metrics of the one or more companies. Further, the generating of the company fair value data includes generating the estimated fair value of the one or more companies using the one or more asset metrics, the one or more present earning metrics, and the one or more future earning metrics.

In some embodiments, the extracting of the one or more financial metrics further may include computing a Net Tangible Asset to Price Ratio (NTPR) using the one or more asset metrics of the one or more companies. Further, the extracting of the one or more financial metrics further may include computing a Discounted Earnings to Price Ratio (DEPR) by extrapolating one or more of the one or more present earning metrics of the one or more companies and the one or more future earning metrics of the one or more companies. Further, the extracting of the one or more financial metrics further may include computing a Discounted Terminal Earnings to Price Ratio (DTPR) using the DEPR and one or more model parameters. Further, the one or more model parameters include one or more of a terminal multiplier and a number of years for a growth phase. Further, the generating of the stock fair value data may be based on the computing of the NTPR, the computing of the DEPR, and the computing of the DTPR.

In some embodiments, the one or more financial metrics may include a Net Tangible Asset to Price Ratio (NTPR), a Discounted Earnings to Price Ratio (DEPR), and a Discounted Terminal Earnings to Price Ratio (DTPR). Further, the generating of the company fair value data may include computing a sum of the NTPR, the DEPR, and the DTPR of the one or more companies. Further, the generating of the company fair value data may include obtaining the estimated fair value of the one or more companies based on the computing of the sum. Further, the generating of the one or more stock fair value data may be based on the obtaining of the estimated fair value of the one or more companies.

In some embodiments, the generating of the stock fair value data includes generating the stock fair value data based on the one or more financial metrics using one or more model parameters. Further, the one or more model parameters may be dynamically updated.

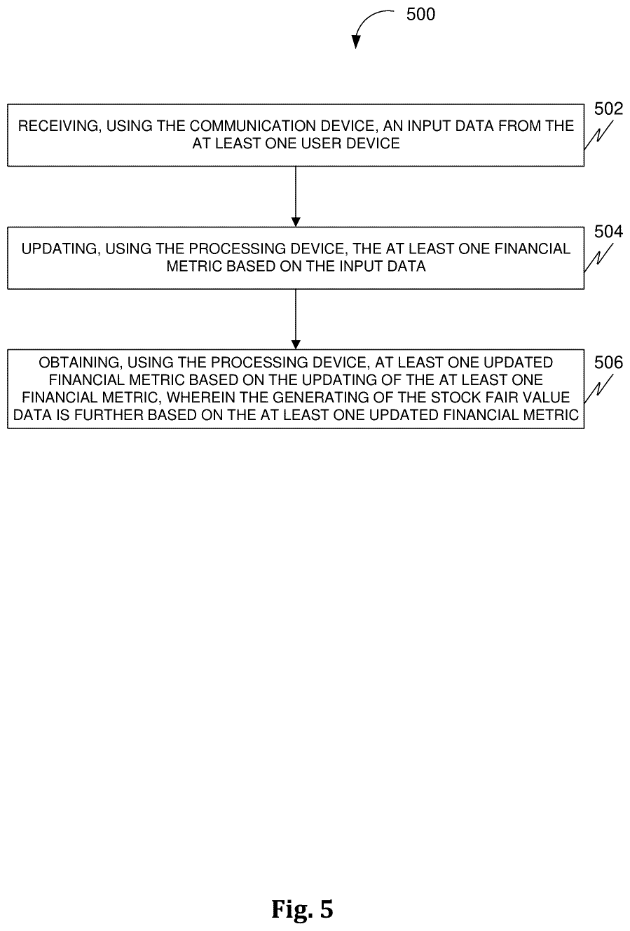

FIG. 5 illustrates a flowchart of a method 500 of facilitating stock valuation including obtaining, using the processing device 904, at least one updated financial metric, in accordance with some embodiments. Further, in some embodiments, the method 500 further may include a step 502 of receiving, using the communication device 902, an input data from the one or more user devices. Further, the input data represents one or more user inputs associated with the one or more financial metrics. Further, the input data may represent one or more inputs associated with the one or more model parameters. Further, the one or more inputs may include one or more values of the one or more model parameters. Further, in some embodiments, the method 500 further may include a step 504 of updating, using the processing device 904, the one or more financial metrics based on the input data. Further, in some embodiments, the method 500 further may include a step 506 of obtaining, using the processing device 904, one or more updated financial metrics based on the updating of the one or more financial metrics. Further, the generating of the stock fair value data may be further based on the one or more updated financial metrics.

Further, in some embodiments, the input data may include at least one parameter data representing at least one user preferred value for the at least one financial metric.

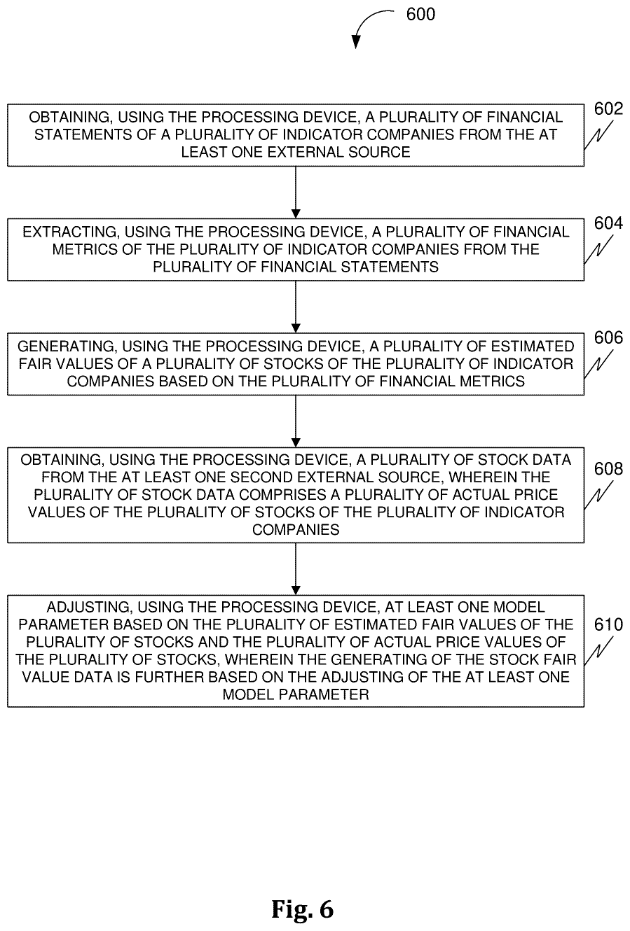

FIG. 6 illustrates a flowchart of a method 600 of facilitating stock valuation including adjusting, using the processing device 904, at least one model parameter, in accordance with some embodiments. Further, in some embodiments, the method 600 further may include a step 602 of obtaining, using the processing device 904, two or more financial statements of two or more indicator companies from the one or more external sources. Further, in some embodiments, the method 600 further may include a step 604 of extracting, using the processing device 904, two or more financial metrics of the two or more indicator companies from the two or more financial statements. Further, in some embodiments, the method 600 further may include a step 606 of generating, using the processing device 904, two or more estimated fair values of two or more stocks of the two or more indicator companies based on the two or more financial metrics. Further, in some embodiments, the method 600 further may include a step 608 of obtaining, using the processing device 904, two or more stock data from the one or more second external sources. Further, the two or more stock data includes two or more actual price values of the two or more stocks of the two or more indicator companies. Further, in some embodiments, the method 600 further may include a step 610 of adjusting, using the processing device 904, one or more model parameters based on the two or more estimated fair values of the two or more stocks and the two or more actual price values of the two or more stocks. Further, the generating of the stock fair value data may be further based on the adjusting of the one or more model parameters.

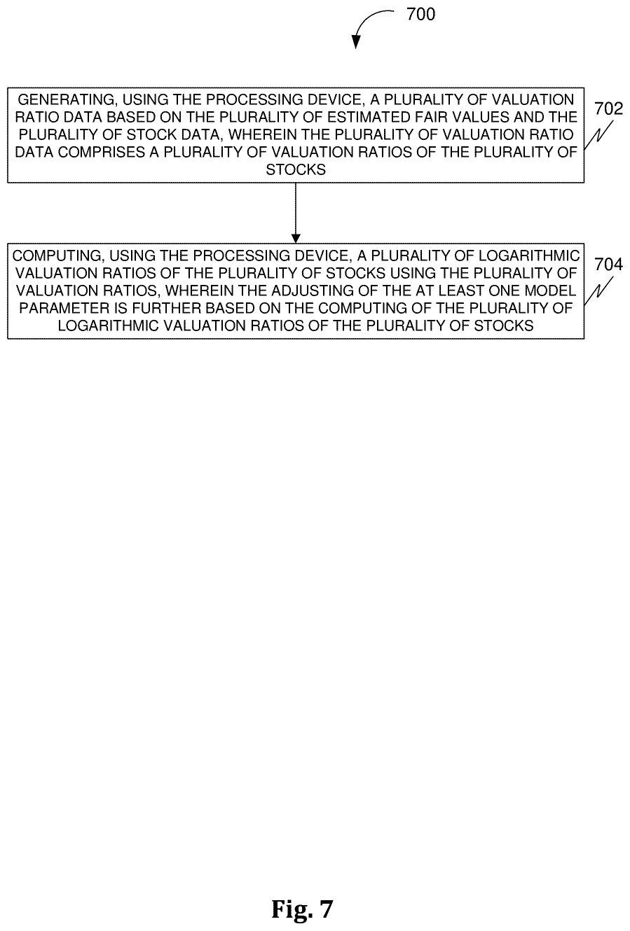

FIG. 7 illustrates a flowchart of a method 700 of facilitating stock valuation including computing, using the processing device 904, a plurality of logarithmic valuation ratios of the plurality of stocks using the plurality of valuation ratios, in accordance with some embodiments. Further, in some embodiments, the method 700 further may include a step 702 of generating, using the processing device 904, two or more valuation ratio data based on the two or more estimated fair values and the two or more stock data. Further, the two or more valuation ratio data includes two or more valuation ratios of the two or more stocks. Further, in some embodiments, the method 700 further may include a step 704 of computing, using the processing device 904, two or more logarithmic valuation ratios of the two or more stocks using the two or more valuation ratios. Further, the adjusting of the one or more model parameters may be further based on the computing of the two or more logarithmic valuation ratios of the two or more stocks.

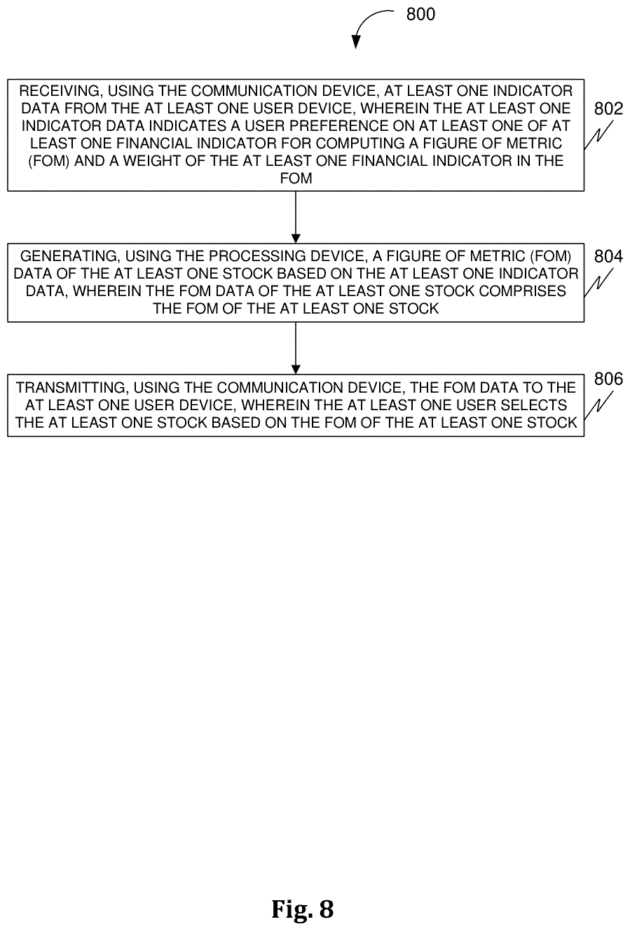

FIG. 8 illustrates a flowchart of a method 800 of facilitating stock valuation including generating, using the processing device 904, a Screener Figure of Metric (SFOM) data of the at least one stock, in accordance with some embodiments. Further, in some embodiments, the method 800 further may include a step 802 of receiving, using the communication device 902, one or more indicator data from the one or more user devices. Further, the one or more indicator data indicate a user preference on one or more of one or more financial indicators for computing a Screener Figure of Merit (SFOM) and a weight of the one or more financial indicators in the SFOM. Further, in some embodiments, the method 800 further may include a step 804 of generating, using the processing device 904, a Screener Figure of Metric (SFOM) data of the one or more stocks based on the one or more indicator data. Further, the SFOM data of the one or more stocks includes the SFOM of the one or more stocks. Further, in some embodiments, the method 800 further may include a step 806 of transmitting, using the communication device 902, the SFOM data to the one or more user devices. Further, the one or more users select one or more stocks based on the SFOM of the one or more stocks.

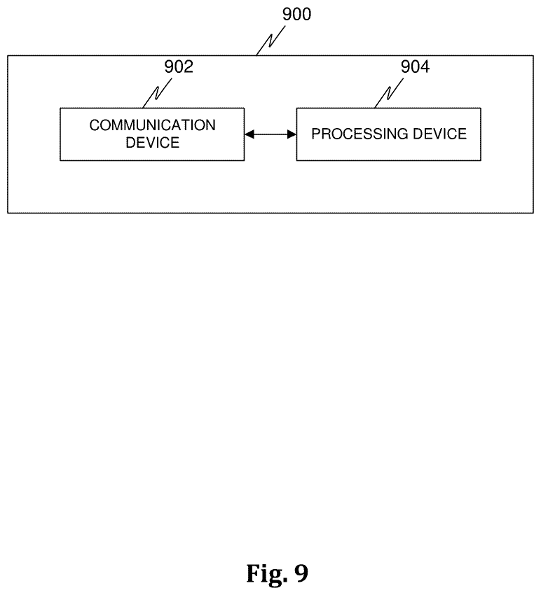

FIG. 9 illustrates a block diagram of a system 900 of facilitating stock valuation, in accordance with some embodiments. Further, the system 900 may include a communication device 902. Further, the communication device 902 may be configured for receiving one or more company data from one or more user devices associated with one or more users. Further, the one or more company data indicate one or more companies to perform the stock valuation. Further, the communication device 902 may be configured for transmitting a valuation ratio data to the one or more user devices. Further, the system 900 may include a processing device 904 communicatively coupled with the communication device 902. Further, the processing device 904 may be configured for obtaining one or more financial statements of the one or more companies from one or more first external sources based on the one or more company data. Further, the processing device 904 may be configured for extracting one or more financial metrics of the one or more companies from the one or more financial statements. Further, the processing device 904 may be configured for generating a stock fair value data based on the one or more financial metrics. Further, the stock fair value data includes an estimated fair value of one or more stocks of the one or more companies. Further, the processing device 904 may be configured for obtaining a stock data from one or more second external sources. Further, the stock data includes an actual price value of the one or more stocks of the one or more companies. Further, the processing device 904 may be configured for generating the valuation ratio data based on the stock fair value data and the stock data. Further, the valuation ratio data includes a valuation ratio of the one or more stocks.

Further, in some embodiments, the processing device 904 may be configured for generating a company fair value data based on the one or more financial metrics. Further, the company fair value data includes an estimated fair value of the one or more companies. Further, the processing device 904 may be configured for obtaining a share data of the one or more companies from the one or more second external sources. Further, the share data indicates a total number of shares of the one or more companies. Further, the generating of the stock fair value data may be further based on each of the company fair value data and the share data.

In some embodiments, the extracting of the one or more financial metrics may include extracting one or more asset metrics of the one or more companies based on the one or more financial statements. Further, the extracting of the one or more financial metrics may include extracting one or more present earning metrics of the one or more companies based on the one or more financial statements. Further, the extracting of the one or more financial metrics may include estimating one or more future earning metrics of the one or more companies based on the one or more financial statements. Further, the generating of the company fair value data may be based on the extracting of the one or more asset metrics, the extracting of the one or more present earning metrics, and the estimating of the one or more future earning metrics of the one or more companies. Further, the generating of the company fair value data includes generating the estimated fair value of the one or more companies using the one or more asset metrics, the one or more present earning metrics, and the one or more future earning metrics.

In some embodiments, the extracting of the one or more financial metrics further may include computing a Net Tangible Asset to Price Ratio (NTPR) using the one or more asset metrics of the one or more companies. Further, the extracting of the one or more financial metrics further may include computing a Discounted Earnings to Price Ratio (DEPR) by extrapolating one or more of the one or more present earning metrics of the one or more companies and the one or more future earning metrics of the one or more companies. Further, the extracting of the one or more financial metrics further may include computing a Discounted Terminal Earnings to Price Ratio (DTPR) using the DEPR and one or more model parameters. Further, the one or more model parameters include one or more of a terminal multiplier and a number of years for a growth phase. Further, the generating of the stock fair value data may be based on the computing of the NTPR, the computing of the DEPR, and the computing of the DTPR.

In some embodiments, the one or more financial metrics may include a Net Tangible Asset to Price Ratio (NTPR), a Discounted Earnings to Price Ratio (DEPR), and a Discounted Terminal Earnings to Price Ratio (DTPR). Further, the generating of the company fair value data may include computing a sum of the NTPR, the DEPR, and the DTPR of the one or more companies. Further, the generating of the company fair value data may include obtaining the estimated fair value of the one or more companies based on the computing of the sum. Further, the generating of the one or more stock fair value data may be based on the obtaining of the estimated fair value of the one or more companies.

In some embodiments, the generating of the stock fair value data includes generating the stock fair value data based on the one or more financial metrics using one or more model parameters. Further, the one or more model parameters may be dynamically updated.

Further, in some embodiments, the communication device 902 may be further configured for receiving an input data from the one or more user devices. Further, the input data may represent one or more user inputs associated with the one or more financial metrics. Further, the processing device 904 may be further configured for updating the one or more financial metrics based on the input data. Further, the processing device 904 may be further configured for obtaining one or more updated financial metrics based on the updating of the one or more financial metrics. Further, the generating of the stock fair value data may be further based on the one or more updated financial metrics.

Further, in some embodiments, the processing device 904 may be further configured for obtaining two or more financial statements of two or more indicator companies from the one or more external sources. Further, the processing device 904 may be further configured for extracting two or more financial metrics of the two or more indicator companies from the two or more financial statements. Further, the processing device 904 may be further configured for generating two or more estimated fair values of two or more stocks of the two or more indicator companies based on the two or more financial metrics. Further, the processing device 904 may be further configured for obtaining two or more stock data from the one or more second external sources. Further, the two or more stock data includes two or more actual price values of the two or more stocks of the two or more indicator companies. Further, the processing device 904 may be further configured for adjusting one or more model parameters based on the two or more estimated fair values of the two or more stocks and the two or more actual price values of the two or more stocks. Further, the generating of the stock fair value data may be further based on the adjusting of the one or more model parameters.

Further, in some embodiments, the processing device 904 may be further configured for generating two or more valuation ratio data based on the two or more estimated fair values and the two or more stock data. Further, the two or more valuation ratio data includes two or more valuation ratios of the two or more stocks. Further, the processing device 904 may be further configured for computing two or more logarithmic valuation ratios of the two or more stocks using the two or more valuation ratios. Further, the adjusting of the one or more model parameters may be further based on the computing of the two or more logarithmic valuation ratios of the two or more stocks.

Further, in some embodiments, the communication device 902 may be further configured for receiving one or more indicator data from the one or more user devices. Further, the one or more indicator data indicate a user preference on one or more of one or more financial indicators for computing a Screener Figure of Merit (SFOM) and a weight of the one or more financial indicators in the SFOM. Further, the communication device 902 may be further configured for transmitting a SFOM data to the one or more user devices. Further, the one or more users selects the one or more stocks based on the SFOM of the one or more stocks. Further, the processing device 904 may be configured for generating the Screener Figure of Merit (SFOM) data of the one or more stocks based on the one or more indicator data. Further, the SFOM data of the one or more stocks includes the SFOM of the one or more stocks.

In some embodiments, the generating of the stock fair value data includes dividing the estimated fair value of the one or more companies by the total number of shares of the one or more companies to obtain the estimated fair value of the one or more stocks.

In some embodiments, the one or more model parameters include one or more of a discount rate, a number of years for a growth phase, a delay parameter, a terminal multiplier, and a growth limit.

In some embodiments, the one or more financial statements of the one or more companies include one or more of an income statement of the one or more companies and a balance sheet of the one or more companies.

In some embodiments, the extracting of the one or more financial metrics includes extracting the one or more financial metrics from the one or more financial statements using one or more extraction techniques. Further, the one or more extraction techniques include one or more of a heuristic-based technique, a data filtering based technique, an interpolation technique, and an extrapolation technique.

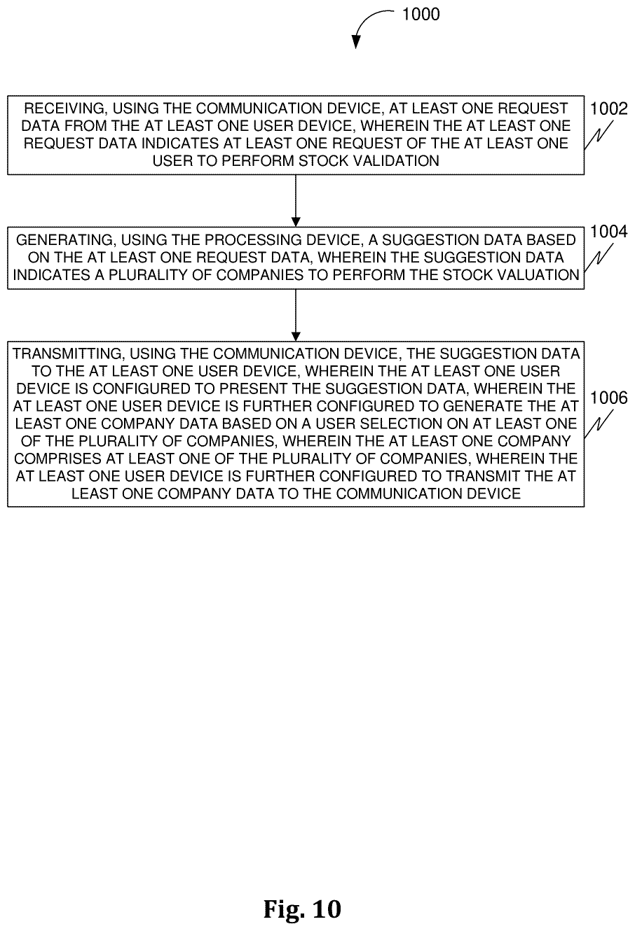

FIG. 10 illustrates a flowchart of a method 1000 of facilitating stock valuation including generating, using the processing device 904, a suggestion data, in accordance with some embodiments. Further, in some embodiments, the method 1000 further may include a step 1002 of receiving, using the communication device 902, one or more request data from the one or more user devices. Further, the one or more request data indicate one or more requests of the one or more users to perform stock valuation. Further, in some embodiments, the method 1000 further may include a step 1004 of generating, using the processing device 904, a suggestion data based on the one or more request data. Further, the suggestion data indicates two or more companies to perform the stock valuation. Further, in some embodiments, the method 1000 further may include a step 1006 of transmitting, using the communication device 902, the suggestion data to the one or more user devices. Further, the one or more user devices may be configured to present the suggestion data. Further, the one or more user devices may be further configured to generate the one or more company data based on a user selection on one or more of the two or more companies. Further, the one or more companies include one or more of the two or more companies. Further, the one or more user devices may be further configured to transmit the one or more company data to the communication device 902.

In some embodiments, the one or more company data includes one or more of a name of the one or more companies and a ticker symbol of the one or more companies.

In some embodiments, the suggestion data includes an industry data indicating an industry of the two or more companies. Further, the presenting of the suggestion data includes presenting the two or more companies based on the industry of the two or more companies.

In some embodiments, the industry of the two or more companies includes one or more of a car manufacturing industry, a semiconductor industry, and an airline industry.

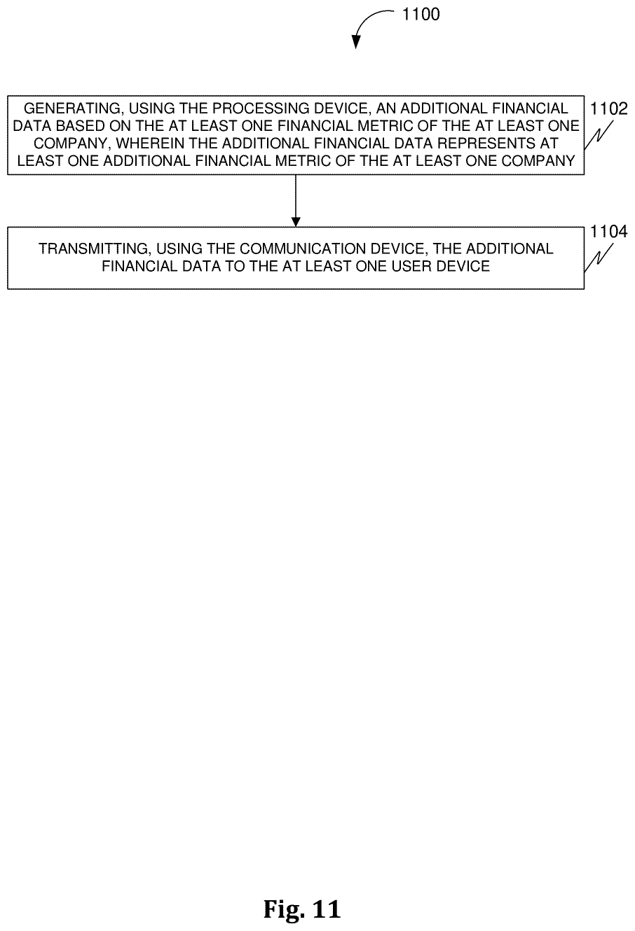

FIG. 11 illustrates a flowchart of a method 1100 of facilitating stock valuation including generating, using the processing device 904, an additional financial data, in accordance with some embodiments. Further, in some embodiments, the method 1100 further may include a step 1102 of generating, using the processing device 904, an additional financial data based on the one or more financial metrics of the one or more companies. Further, the additional financial data represents one or more additional financial metrics of the one or more companies. Further, in some embodiments, the method 1100 further may include a step 1104 of transmitting, using the communication device 902, the additional financial data to the one or more user devices.

In some embodiments, the generating of the valuation ratio data includes generating the valuation ratio based on the stock fair value data and the stock data. Further, the valuation ratio corresponds to a ratio of the estimation fair value of the one or more stocks to the actual price value of the one or more stocks. Further, the valuation ratio of the one or more stocks may be one of greater than one and less than one.

In some embodiments, the valuation ratio of the one or more stocks greater than one indicates an undervaluation of the one or more stocks. Further, the actual price value of the one or more stocks may be lower than the estimated fair value of the one or more stocks in the undervaluation of the one or more stocks.

In some embodiments, the valuation ratio of the one or more stocks less than one indicates an overvaluation of the one or more stocks. Further, the actual price value of the one or more stocks may be greater than the estimated fair value of the one or more stocks in the undervaluation of the one or more stocks.

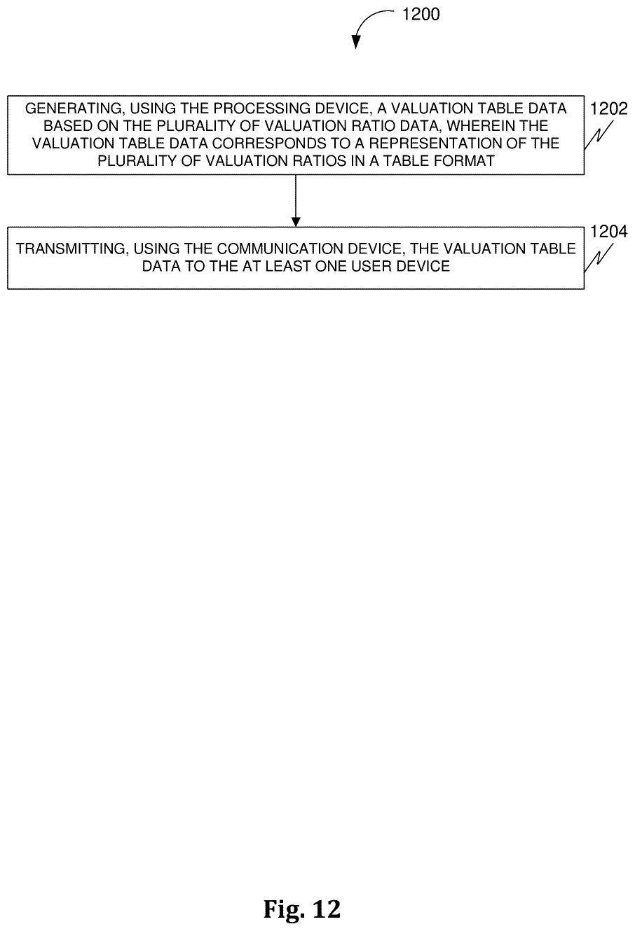

FIG. 12 illustrates a flowchart of a method 1200 of facilitating stock valuation including generating, using the processing device 904, a valuation table data, in accordance with some embodiments. Further, in some embodiments, the one or more company data indicate two or more companies to perform the stock valuation. Further, the generating of the valuation ratio data may include generating two or more valuation ratio data. Further, the two or more valuation ratio data may include two or more valuation ratios of two or more stocks of the two or more companies. Further, the method 1200 further may include a step 1802 of generating, using the processing device 904, a valuation table data based on the two or more valuation ratio data. Further, the valuation table data corresponds to a representation of the two or more valuation ratios in a table format. Further, the generating of the valuation ratio data may include generating two or more valuation ratio data. Further, the method 1800 further may include a step 1804 of transmitting, using the communication device 902, the valuation table data to the one or more user devices.

In some embodiments, the one or more asset metrics of the one or more companies include one or more of a Total Assets to Price Ratio (TAPR), a Goodwill to Price Ratio (GWPR), and a Total Liabilities to Price Ratio (TLPR).

In some embodiments, the one or more present earning metrics of the one or more companies include one or more of a Total Revenue to Price Ratio (TRPR), an indirect cost, a cost of revenue, and a total revenue.

In some embodiments, the one or more future earning metrics of the one or more companies include one or more of an Average Growth Rate (AVGR), an Estimated Growth Rate (ESGR), a slow growth rate (SLGR), a discount factor, a quarterly rate of growth for AVGR, and a quarterly rate of growth for SLGR.

In some embodiments, the extracting of the one or more financial metrics of the one or more companies includes extracting the one or more financial metrics of the one or more companies using a sigmoid function. Further, the sigmoid function defines one or more model parameters.

In some embodiments, the one or more model parameters include one or more of a discount rate, a time horizon, a time delay, a terminal multiplier, and a growth limit.

In some embodiments, the two or more stocks may be characterized by two or more types.

In some embodiments, the two or more stocks may be characterized by two or more categories. Further, the two or more categories include a small-market capitalization category, a mid-market capitalization category, and a large-market capitalization category.

In some embodiments, the two or more stocks may be characterized by two or more categories. Further, the two or more categories include a growth stock category and a value stock category.

In some embodiments, the method 900 may further include computing, using the processing device 904, a model parameter using the two or more estimated fair values and the two or more stock data. Further, the model parameter indicates a correctness of the two or more estimated fair values in relation to the two or more actual price values. Further, the adjusting of the one or more model parameters may be further based on the model parameter.

In some embodiments, the computing of the model parameter includes computing a sum of two or more differences between the plurality of the estimated fair values and the two or more actual price values of the two or more stocks. Further, the adjusting of the one or more model parameters may be based on the computing of the sum of the two or more differences.

In some embodiments, the model parameter includes a value of zero indicating a lack of difference between the plurality of the estimated fair values and the two or more actual price values of the two or more stocks.

In some embodiments, the two or more logarithmic valuation ratios include a value of zero and the two or more valuation ratios include a value of one indicating a lack of difference between the plurality of the estimated fair values and the two or more actual price values of the two or more stocks.

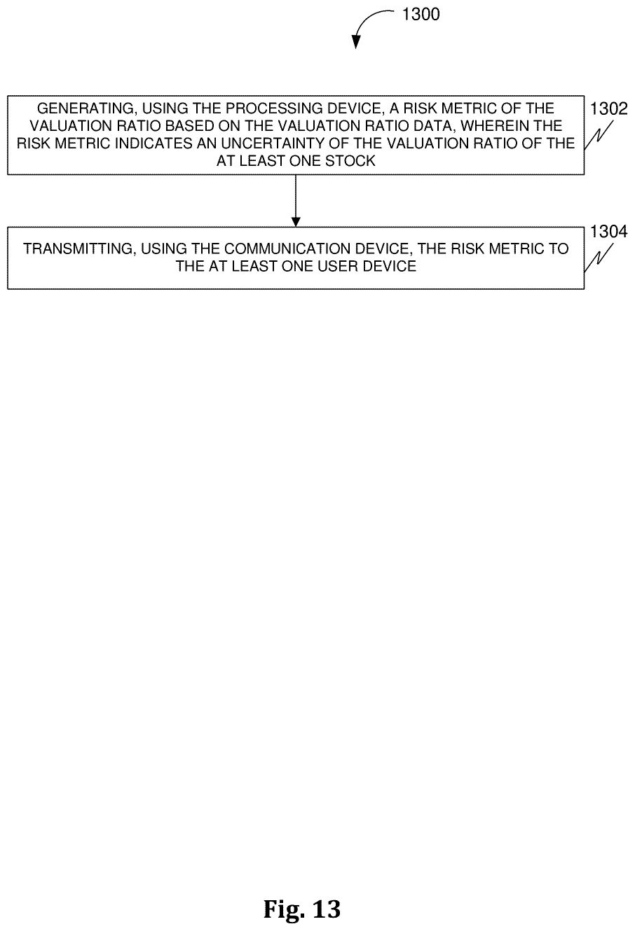

FIG. 13 illustrates a flowchart of a method 1300 of facilitating stock valuation including generating, using the processing device 904, a risk metric of the valuation ratio, in accordance with some embodiments. Further, in some embodiments, the method 1300 further may include a step 1302 of generating, using the processing device 904, a risk metric of the valuation ratio based on the valuation ratio data. Further, the risk metric indicates an uncertainty of the valuation ratio of the one or more stocks. Further, in some embodiments, the method 1300 further may include a step 1304 of transmitting, using the communication device 902, the risk metric to the one or more user devices.

In some embodiments, the generating of the risk metric includes generating a partial derivative of the one or more financial metrics associated with the valuation ratio of the one or more stocks.

In some embodiments, the risk metric includes a root mean square value of the partial derivative of the one or more financial metrics.

In some embodiments, the extracting of the one or more financial metrics includes extracting the one or more financial metrics of the one or more companies from the one or more financial statements using one or more machine learning (ML) models. Further, the one or more ML models may be trained on two or more financial statements to extract the one or more financial metrics. Further, the one or more ML models may be configured to use an adaptive heuristic.

Further, the one or more ML models may include one or more ML model parameters. Further, the one or more ML model parameters may be determined from theoretical considerations, derived from the two or more financial statements, or obtained by training the one or more ML models.

In some embodiments, the generating of the stock fair value data includes generating the stock fair value data using one or more artificial intelligence (AI) models based on the one or more financial metrics. Further, the one or more AI models may be configured to estimate the estimated fair value of the one or more stocks using the one or more financial metrics.

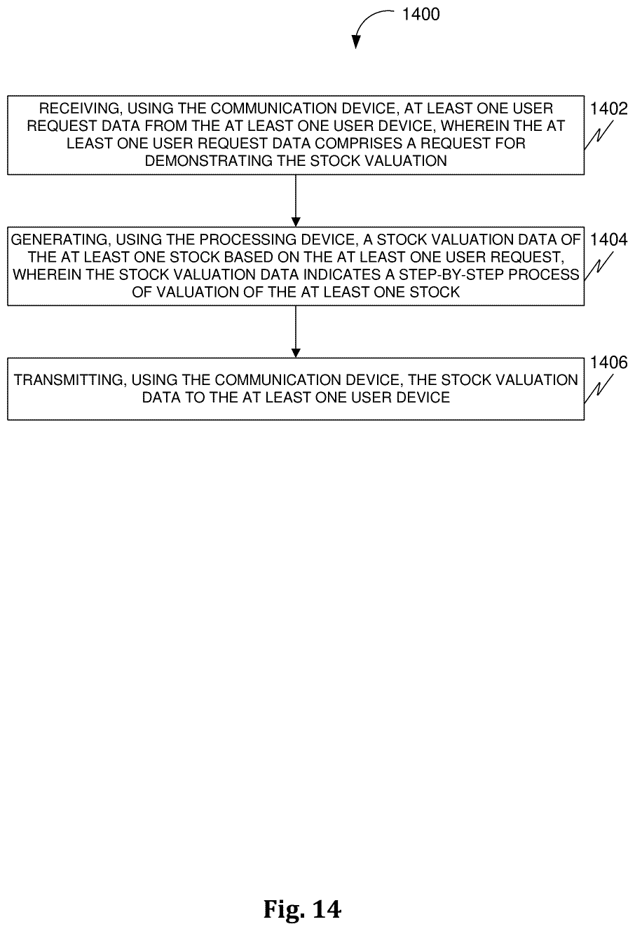

FIG. 14 illustrates a flowchart of a method 1400 of facilitating stock valuation including generating, using the processing device 904, a stock valuation data of the at least one stock, in accordance with some embodiments. Further, in some embodiments, the method 1400 further may include a step 1402 of receiving, using the communication device 902, one or more user request data from the one or more user devices. Further, the one or more user request data includes a request for demonstrating the stock valuation. Further, in some embodiments, the method 1400 further may include a step 1404 of generating, using the processing device 904, a stock valuation data of the one or more stocks based on the one or more user requests. Further, the stock valuation data indicates a step-by-step process of valuation of the one or more stocks. Further, in some embodiments, the method 1400 further may include a step 1406 of transmitting, using the communication device 902, the stock valuation data to the one or more user devices.

In some embodiments, the stock valuation data includes one or more of an audio data, a video data, and an image data.

In some embodiments, the method 300 may further include updating, using the processing device 904, the one or more model parameters using an artificial intelligence (AI) model. Further, the AI model may be configured to update the one or more model parameters based on an uncertainty in an industry-specific market. Further, the generating of the stock fair value data may be further based on the updating of the one or more model parameters.

In some embodiments, the AI model may be further configured to update the one or more model parameters based on a historical revenue variance of the one or more companies.

In some embodiments, the one or more variation parameters include a discount rate.

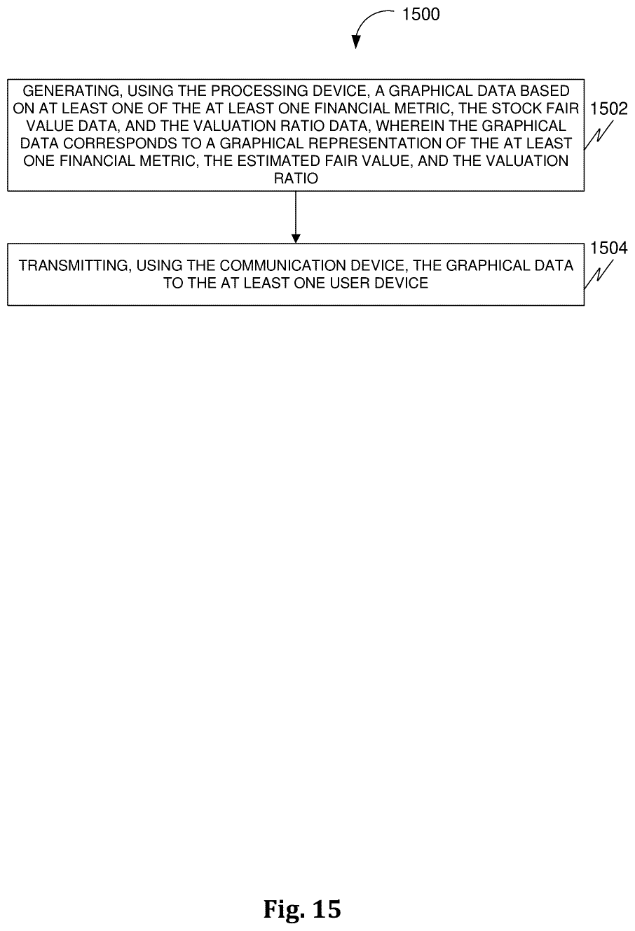

FIG. 15 illustrates a flowchart of a method 1500 of facilitating stock valuation including generating, using the processing device 904, a graphical data, in accordance with some embodiments. Further, in some embodiments, the method 1500 further may include a step 1502 of generating, using the processing device 904, a graphical data based on one or more of the one or more financial metrics, the stock fair value data, and the valuation ratio data. Further, the graphical data corresponds to a graphical representation of the one or more financial metrics, the estimated fair value, and the valuation ratio. Further, in some embodiments, the method 1500 further may include a step 1504 of transmitting, using the communication device 902, the graphical data to the one or more user devices.

In some embodiments, the graphical data corresponds to a multi-resolution graph.

In some embodiments, the graphical data corresponds to a heat map.

In some embodiments, the one or more financial metrics include two or more financial metrics. Further, the generating of the stock fair value data includes extrapolating the two or more financial metrics using two or more growth rates to obtain the estimated stock fair value.

In some embodiments, the generating of the stock fair value data may include extrapolating a revenue of the one or more companies using an average growth rate. Further, the generating of the stock fair value data may include extrapolating an indirect cost of the one or more companies using a delay parameter corresponding to a slow growth rate. Further, the delay parameter uses an exponential formula. Further, the two or more growth rates include the average growth rate and the slow growth rate.

In some embodiments, the one or more companies include a fast-growing company.

In some embodiments, the sigmoid function includes one or more of a logistic curve, a hyperbolic tangent, and an error function.

In some embodiments, the extracting the one or more financial metrics of the one or more companies using the sigmoid function includes adjusting the growth limit based on an industry-specific volatility index.

In some embodiments, the extracting of the one or more financial metrics includes extracting the one or more financial metrics from the one or more financial statements using a natural language processing (NLP) model.

In some embodiments, the one or more first external sources and the one or more second external sources may be the same.

In some embodiments, the one or more first external sources and the one or more second external sources may be different.

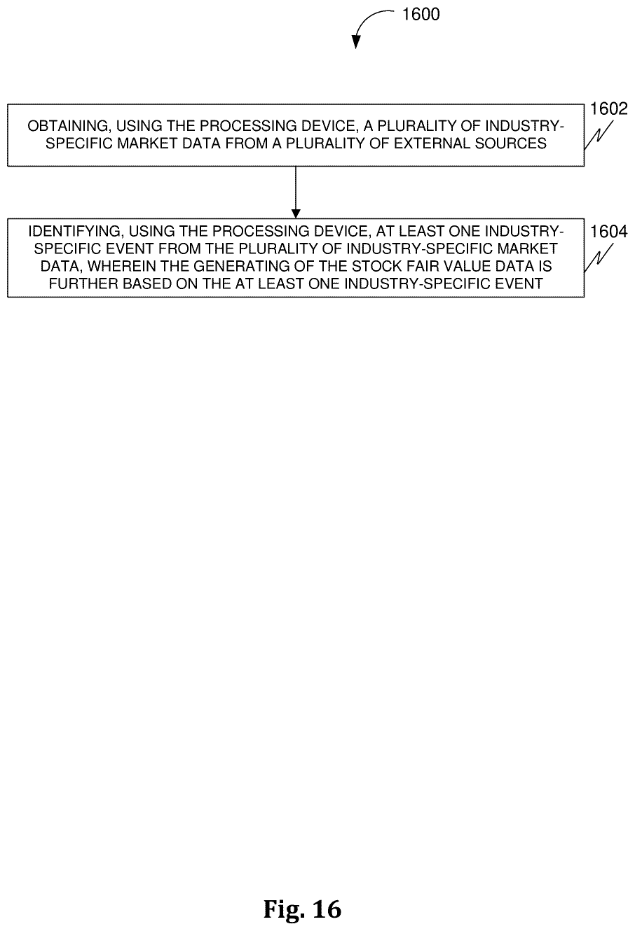

FIG. 16 illustrates a flowchart of a method 1600 of facilitating stock valuation including identifying, using the processing device 904, at least one industry-specific event from the plurality of industry-specific market data, in accordance with some embodiments. Further, in some embodiments, the method 1600 further may include a step 1602 of obtaining, using the processing device 904, two or more industry-specific market data from two or more external sources. Further, in some embodiments, the method 1600 further may include a step 1604 of identifying, using the processing device 904, one or more industry-specific events from the two or more industry-specific market data. Further, the generating of the stock fair value data may be further based on the one or more industry-specific events.

In some embodiments, the two or more industry-specific market data include a news feed. Further, the one or more industry-specific events correspond to a guidance update associated with the one or more companies, and a dividend change of the one or more companies.

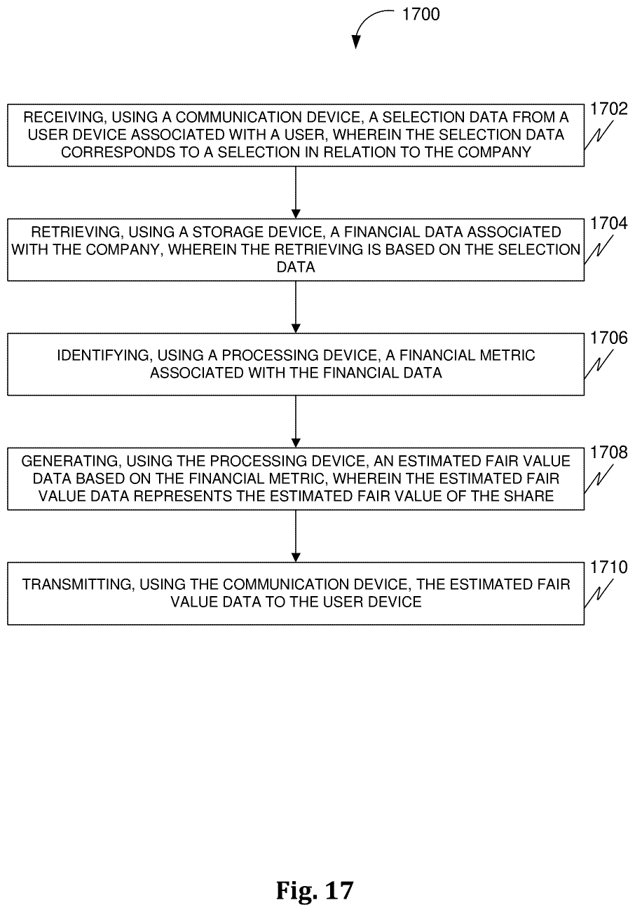

FIG. 17 illustrates a flowchart of a method 1700 of generating an estimated fair value of a share associated with a company, in accordance with some embodiments. Further, the method 1700 may include a step 1702 of receiving, using a communication device 2002, a selection data from a user device associated with a user. Further, the selection data corresponds to a selection in relation to the company. Further, the method 1700 may include a step 1704 of retrieving, using a storage device 2004, a financial data associated with the company. Further, the retrieving may be based on the selection data. Further, the method 1700 may include a step 1706 of identifying, using a processing device 2006, a financial metric associated with the financial data. Further, the method 1700 may include a step 1708 of generating, using the processing device 2006, an estimated fair value data based on the financial metric. Further, the estimated fair value data represents the estimated fair value of the share. Further, the method 1700 may include a step 1710 of transmitting, using the communication device 2002, the estimated fair value data to the user device.

In some embodiments, the company includes two or more companies. Further, the selection data includes one or more of a company list data and a ticker symbol selection data. Further, the company list data corresponds to a list of the selection in relation to the two or more companies. Further, the ticker symbol selection data corresponds to the selection of a ticker symbol associated with the company.

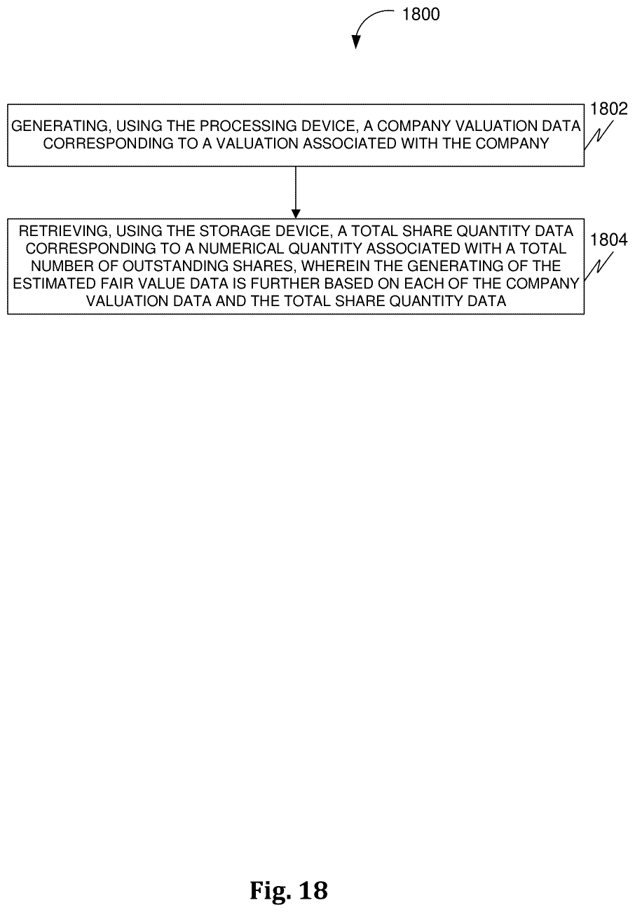

FIG. 18 illustrates a flowchart of a method 1800 of generating an estimated fair value of a share associated with a company including retrieving, using the storage device 2004, a total share quantity data corresponding to a numerical quantity associated with a total number of outstanding shares, in accordance with some embodiments. Further, in some embodiments, the method 1800 further may include a step 1802 of generating, using the processing device 2006, a company valuation data corresponding to a valuation associated with the company. Further, in some embodiments, the method 1800 further may include a step 1804 of retrieving, using the storage device 2004, a total share quantity data corresponding to a numerical quantity associated with a total number of outstanding shares. Further, the generating of the estimated fair value data may be further based on each of the company valuation data and the total share quantity data.

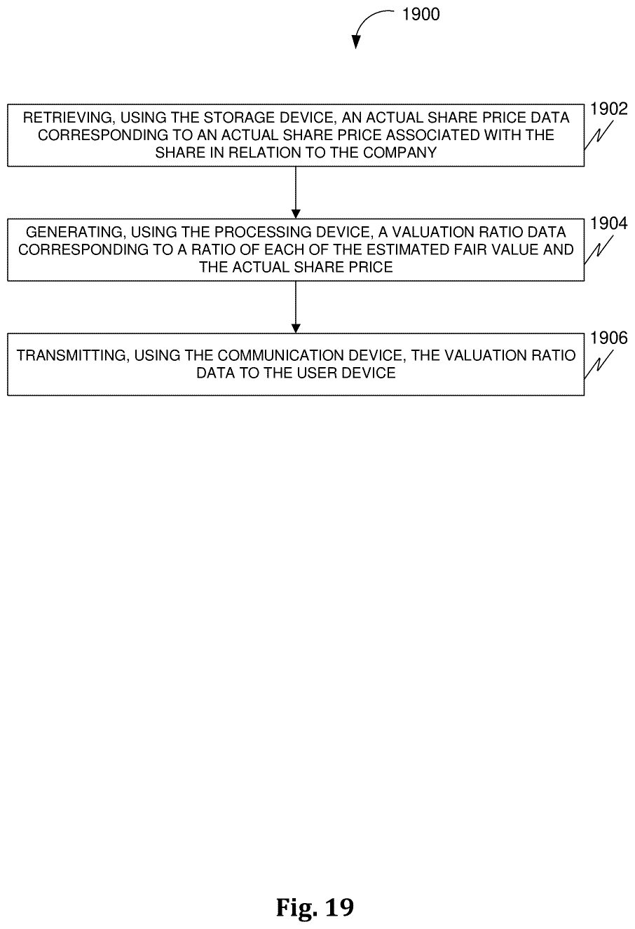

FIG. 19 illustrates a flowchart of a method 1900 of generating an estimated fair value of a share associated with a company including generating, using the processing device 2006, a valuation ratio data corresponding to a ratio of each of the estimated fair value and the actual share price, in accordance with some embodiments. Further, in some embodiments, the method 1900, further may include a step 1902 of retrieving, using the storage device 2004, an actual share price data corresponding to an actual share price associated with the share in relation to the company. Further, in some embodiments, the method 1900, further may include a step 1904 of generating, using the processing device 2006, a valuation ratio data corresponding to a ratio of each of the estimated fair value and the actual share price. Further, in some embodiments, the method 1900, further may include a step 1906 of transmitting, using the communication device 2002, the valuation ratio data to the user device.

In some embodiments, the method 1900 may further include generating, using the processing device 2006, a financial overview data corresponding to an additional financial insight in relation to the share associated with the company. Further, the estimated fair value data includes the financial overview data.

In some embodiments, the estimated fair value data may be further configured to be presented on the user presentation device associated with the user device. Further, the user device includes a user input device which may be configured for receiving a user input data corresponding to a user input. Further, the user device further includes a user processing device which may be configured for generating a user input-based result data corresponding to a result based on the user input. Further, the user presentation device may be further configured to present the user input-based result data. Further, the user input data includes a company info-selection data corresponding to the selection to view a company information associated with the company. Further, the user input-based result data includes a company data corresponding to the company information.

In some embodiments, the generating of company valuation data may be further based on a summation of each of a net tangible asset, a discounted value of a future earning based on a fixed time period and the discounted value of a terminal earning multiplied by a fixed multiple. Further, the net tangible asset corresponds to a difference of a total asset associated with the company and each of a total liability associated with the company and an intangible asset. Further, the terminal earning corresponds to an earning during an end of the fixed time period.

In some embodiments, the generating of the estimated fair value data may be further based on dividing the company valuation data with the total share quantity data.

In some embodiments, each of the identifying of the financial metric and the generating of the estimated fair value data may be based on an AI module. Further, the AI module includes a valuation module which may be configured to provision the estimated fair value of the stock.

In some embodiments, the method 1900 may further include calibrating, using the processing device 2006, the valuation model based on each of a calibration parameter and a calibration sample. Further, the calibration parameter corresponds to a parameter which may be configured to be adjusted to refine a performance associated with the valuation model. Further, the calibration sample corresponds to a sample which may be configured to calibrate the valuation model. Further, the calibration parameter includes one or more of a discount rate, a time horizon, a time delay, a terminal multiplier, and a growth limit. Further, the calibration sample includes two or more financial data associated with two or more companies. Further, each of the two or more companies may be associated with two or more characteristics. Further, the two or more characteristics includes one or more of a company category, a company market capitalization, and a company share type. Further, the company category corresponds to an operating sector associated with the company. Further, the company market capitalization corresponds to a market capitalization associated with the company. Further, the company share type corresponds to a type associated with the share of the company.

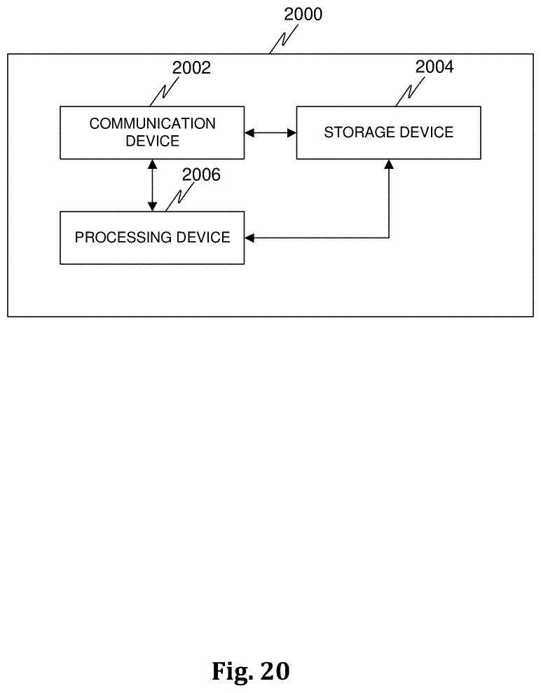

FIG. 20 illustrates a block diagram of a system 2000 of generating an estimated fair value of a share associated with a company, in accordance with some embodiments. Further, the system 2000 may include a communication device 2002. Further, the communication device 2002 may be configured for receiving a selection data from a user device associated with a user. Further, the selection data corresponds to a selection in relation to the company. Further, the communication device 2002 may be configured for transmitting an estimated fair value data to the user device. Further, the system 2000 may include a storage device 2004 which may be configured for retrieving a financial data associated with the company. Further, the retrieving may be based on the selection data. Further, the system 2000 may include a processing device 2006. Further, the processing device 2006 may be configured for identifying a financial metric associated with the financial data. Further, the processing device 2006 may be configured for generating the estimated fair value data based on the financial metric. Further, the estimated fair value data represents the estimated fair value of the share.

In some embodiments, the company includes two or more companies. Further, the selection data includes one or more of a company list data and a ticker symbol selection data. Further, the company list data corresponds to a list of the selection in relation to the two or more companies. Further, the ticker symbol selection data corresponds to the selection of a ticker symbol associated with the company.

In some embodiments, the processing device 2006 may be further configured for generating a company valuation data corresponding to a valuation associated with the company. Further, the storage device 2004 may be further configured for retrieving a total share quantity data corresponding to a numerical quantity associated with a total number of outstanding shares. Further, the generating of the estimated fair value data may be further based on each of the company valuation data and the total share quantity data.

In some embodiments, the storage device 2004 may be further configured for retrieving an actual share price data corresponding to an actual share price associated with the share in relation to the company. Further, the processing device 2006 may be further configured for generating a valuation ratio data corresponding to a ratio of each of the estimated fair value and the actual share price. Further, the communication device 2002 may be further configured for transmitting the valuation ratio data to the user device.

In some embodiments, the processing device 2006 may be further configured for generating a financial overview data corresponding to an additional financial insight in relation to the share associated with the company. Further, the estimated fair value data includes the financial overview data.

In some embodiments, the estimated fair value data may be further configured to be presented on the user presentation device associated with the user device. Further, the user device includes a user input device which may be configured for receiving a user input data corresponding to a user input. Further, the user device further includes a user processing device which may be configured for generating a user input-based result data corresponding to a result based on the user input. Further, the user presentation device may be further configured to present the user input-based result data. Further, the user input data includes a company info-selection data corresponding to the selection to view a company information associated with the company. Further, the user input-based result data includes a company data corresponding to the company information.

In some embodiments, the generating of company valuation data may be further based on a summation of each of a net tangible asset, a discounted value of a future earning based on a fixed time period and the discounted value of a terminal earning multiplied by a fixed multiple. Further, the net tangible asset corresponds to a difference of a total asset associated with the company and each of a total liability associated with the company and an intangible asset. Further, the terminal earning corresponds to an earning during an end of the fixed time period.

In some embodiments, the generating of the estimated fair value data may be further based on dividing the company valuation data with the total share quantity data.

In some embodiments, each of the identifying of the financial metric and the generating of the estimated fair value data may be based on an AI module. Further, the AI module includes a valuation module which may be configured to provision the estimated fair value of the stock.

In some embodiments, the processing device 2006 may be further configured for calibrating the valuation model based on each of a calibration parameter and a calibration sample. Further, the calibration parameter corresponds to a parameter which may be configured to be adjusted to refine a performance associated with the valuation model. Further, the calibration sample corresponds to a sample which may be configured to calibrate the valuation model. Further, the calibration parameter includes one or more of a discount rate, a time horizon, a time delay, a terminal multiplier and a growth limit. Further, the calibration sample includes two or more financial data associated with two or more companies. Further, each of the two or more companies may be associated with two or more characteristics. Further, the two or more characteristics includes one or more of a company category, a company market capitalization and a company share type. Further, the company category corresponds to an operating sector associated with the company. Further, the company market capitalization corresponds to a market capitalization associated with the company. Further, the company share type corresponds to a type associated with the share of the company.

In some embodiments, the selection data includes a company category data corresponding to a category associated with the company.

In some embodiments, the financial data includes one or more of an income statement data and a balance sheet data. Further, the income statement data represents one or more of a revenue, an expense and a profit in a specific duration associated with the company. Further, the balance sheet data corresponds to a financial position associated with the company.

In some embodiments, the financial metric includes one or more of a baseline quarterly revenue, a yearly revenue growth, a cost of revenue as a percentage of revenue and an indirect cost as a percentage.

In some embodiments, the valuation ratio data includes one or more of a share undervaluing data and a share overvaluing data. Further, the share undervaluing data corresponds to the valuation ratio greater than one. Further, the overvaluing data corresponds to the valuation data smaller than one.

In some embodiments, the financial overview data includes one or more of a sigma data, an average revenue growth data, a profit margin data, a net income to price ratio data and a price to earnings ratio data. Further, the sigma data corresponding to a standard deviation associated with the valuation ratio. Further, the average revenue growth data corresponds to an average revenue growth associated with the company. Further, the profit margin data represents a net income to a revenue ratio associated with the company. Further, the net income to price ratio data corresponds to a return based on a stock associated with the company. Further, the price to earnings ratio data represents a ratio associated with an actual share price to an earning in relation to the company.

In some embodiments, the company may data includes a company revenue graph data corresponding to a graphical representation of the revenue associated with the company.

In some embodiments, the selection data includes a user-customization data corresponding to a user customization in relation to identifying the financial metric based on the financial data.

In some embodiments, the intangible asset includes a goodwill associated with the company.

In some embodiments, the discounted value may be associated with a discount range corresponding to a range of a discounted value. Further, the discount range includes a five percent to ten percent range.

In some embodiments, the fixed time period may be associated with a time range corresponding to a range of the fixed time period. Further, the time range includes a five years to ten years range.

In some embodiments, the fixed multiple may be associated with a numerical range corresponding to a range constraining the numerical value associated with the fixed multiple. Further, the numerical range includes a five to twenty range.

In some embodiments, the generating of the estimated fair value data may be further based on dividing the company valuation data by the total share quantity data.

In some embodiments, the user-customization data includes a growth limit data corresponding to user customization in relation to a sigmoid function associated with a growth rate of the company.

In some embodiments, the company includes one or more of a small-cap company, a mid-cap company and a large-cap company. Further, the small-cap company corresponds to the company with a small market capitalization. Further, the mid-cap company corresponds to the company with a medium market capitalization. Further, the large-cap company corresponds to the company with a large market capitalization.

In some embodiments, the company market capitalization includes one or more of a small-cap, a mid-cap and a large-cap. Further, the small-cap corresponds to the company with a small market capitalization. Further, the mid-cap corresponds to the company with a medium market capitalization. Further, the large-cap corresponds to the company with a large market capitalization.

In some embodiments, the company share type includes one or more of a growth stock and a value stock.

In some embodiments, the method 1900 may further include generating, using the processing device 2006, a calibration set data corresponding to a set of the two or more companies. Further, the generation of the calibration set may be based on each of the company market capitalization and the company share type.

In some embodiments, the calibration set data includes two or more calibration set data. Further, each of the plurality of the calibration set data includes an equal number of the two or more companies.

In some embodiments, the method 1900 may further include determining, using the processing device 2006, a figure of merit in relation to the valuation model. Further, the figure of merit corresponds to an accuracy associated with the valuation model in relation to the generating of the estimated fair value data.

In some embodiments, the determining may be further based on calculation of a base-2 logarithm of the ration of each of the estimated fair value and an actual price associated with the share.

In some embodiments, the generating of the estimated fair value data may be further based on an assumption. Further, the assumption includes one or more of a constant rate associated with a total revenue growth in relation to the company, the constant rate associated with a cost of revenue growth in relation to the company, a slower rate associated with an indirect cost growth in relation to the cost of revenue growth, a termination of a growth associated with the company at end of the time horizon.

In some embodiments, the sigma data may be computed based on a computational process. Further, the computational process comprising each of the computing a partial derivative of a function in relation to a variable, evaluating the partial derivative in relation to an expected value of the variable, a product of each of the partial derivative and a corresponding standard deviation associated with the variable and a combination of each of two or more products based on a propagation of uncertainty formula.

FIG. 21 illustrates a bar graph 2100 representing a constant-growth assumption, in accordance with some embodiments. Further, the bar graph 2100 is an example of the constant-growth assumption of a total revenue over a time period. Further, the bar graph 2100 corresponds to an established company.

Although the invention has been explained in relation to its preferred embodiment, it is to be understood that many other possible modifications and variations can be made without departing from the spirit and scope of the invention as hereinafter claimed.

What is claimed is:

1. A method of facilitating stock valuation, the method comprising:
receiving, using a communication device, at least one company data from at least one user device associated with at least one user, wherein the at least one company data indicates at least one company to perform the stock valuation;
obtaining, using a processing device, at least one financial statement of the at least one company from at least one first external source based on the at least one company data;
extracting, using the processing device, at least one financial metric of the at least one company from the at least one financial statement;
generating, using the processing device, a stock fair value data based on the at least one financial metric, wherein the stock fair value data comprises an estimated fair value of at least one stock of the at least one company;
obtaining, using the processing device, a stock data from at least one second external source, wherein the stock data comprises an actual price value of the at least one stock of the at least one company;
generating, using the processing device, a valuation ratio data based on the stock fair value data and the stock data, wherein the valuation ratio data comprises a valuation ratio of the at least one stock; and
transmitting, using the communication device, the valuation ratio data to the at least one user device.

2. The method of claim 1 further comprising:
generating, using the processing device, a company fair value data based on the at least one financial metric, wherein the company fair value data comprises an estimated fair value of the at least one company; and
obtaining, using the processing device, a share data of the at least one company from the at least one second external source, wherein the share data indicates a total number of shares of the at least one company, wherein the generating of the stock fair value data is further based on each of the company fair value data and the share data.

3. The method of claim 2, wherein the extracting of the at least one financial metric comprises:
extracting at least one asset metric of the at least one company based on the at least one financial statement;
extracting at least one present earning metric of the at least one company based on the at least one financial statement; and
estimating at least one future earning metric of the at least one company based on the at least one financial statement, wherein the generating of the company fair value data is based on the extracting of the at least one asset metric, the extracting of the at least one present earning metric, and the estimating of the at least one future earning metric of the at least one company, wherein the generating of the company fair value data comprises generating the estimated fair value of the at least one company using the at least one asset metric, the at least one present earning metric, and the at least one future earning metric.

4. The method of claim 3, wherein the extracting of the at least one financial metric further comprises:
computing a Net Tangible Asset to Price Ratio (NTPR) using the at least one asset metric of the at least one company;
computing a Discounted Earnings to Price Ratio (DEPR) by extrapolating at least one of the at least one present earning metric of the at least one company and the at least one future earning metric of the at least one company; and
computing a Discounted Terminal Earnings to Price Ratio (DTPR) using the DEPR and at least one model parameter, wherein the at least one model parameter comprises at least one of a terminal multiplier and a number of years for a growth phase, wherein the generating of the stock fair value data is based on the computing of the NTPR, the computing of the DEPR, and the computing of the DTPR.

5. The method of claim 2, wherein the at least one financial metric comprises a Net Tangible Asset to Price Ratio (NTPR), a Discounted Earnings to Price Ratio (DEPR), and a Discounted Terminal Earnings to Price Ratio (DTPR), wherein the generating of the company fair value data comprises:
computing a sum of the NTPR, the DEPR, and the DTPR of the at least one company; and
obtaining the estimated fair value of the at least one company based on the computing of the sum, wherein the generating of the at least one stock fair value data is based on the obtaining of the estimated fair value of the at least one company.

6. The method of claim 1, wherein the generating of the stock fair value data comprises generating the stock fair value data based on the at least one financial metric using at least one model parameter, wherein the at least one model parameter is dynamically updated.

7. The method of claim 1 further comprising:
receiving, using the communication device, an input data from the at least one user device;
updating, using the processing device, the at least one financial metric based on the input data; and
obtaining, using the processing device, at least one updated financial metric based on the updating of the at least one financial metric, wherein the generating of the stock fair value data is further based on the at least one updated financial metric.

8. The method of claim 6 further comprising:
obtaining, using the processing device, a plurality of financial statements of a plurality of indicator companies from the at least one external source;
extracting, using the processing device, a plurality of financial metrics of the plurality of indicator companies from the plurality of financial statements;
generating, using the processing device, a plurality of estimated fair values of a plurality of stocks of the plurality of indicator companies based on the plurality of financial metrics;
obtaining, using the processing device, a plurality of stock data from the at least one second external source, wherein the plurality of stock data comprises a plurality of actual price values of the plurality of stocks of the plurality of indicator companies; and
adjusting, using the processing device, the at least one model parameter based on the plurality of estimated fair values of the plurality of stocks and the plurality of actual price values of the plurality of stocks, wherein the generating of the stock fair value data is further based on the adjusting of the at least one model parameter.

9. The method of claim 8 further comprising:
generating, using the processing device, a plurality of valuation ratio data based on the plurality of estimated fair values and the plurality of stock data, wherein the plurality of valuation ratio data comprises a plurality of valuation ratios of the plurality of stocks; and
computing, using the processing device, a plurality of logarithmic valuation ratios of the plurality of stocks using the plurality of valuation ratios, wherein the adjusting of the at least one model parameter is further based on the computing of the plurality of logarithmic valuation ratios of the plurality of stocks.

10. The method of claim 1 further comprising:
receiving, using the communication device, at least one indicator data from the at least one user device, wherein the at least one indicator data indicates a user preference on at least one of at least one financial indicator for computing a Screener Figure of Metric (SFOM) and a weight of the at least one financial indicator in the SFOM;
generating, using the processing device, a Screener Figure of Metric (SFOM) data of the at least one stock based on the at least one indicator data, wherein the SFOM data of the at least one stock comprises the SFOM of the at least one stock; and
transmitting, using the communication device, the SFOM data to the at least one user device, wherein the at least one user selects the at least one stock based on the SFOM of the at least one stock.

11. A system for facilitating stock valuation, the system comprising:
a communication device configured for:
receiving at least one company data from at least one user device associated with at least one user, wherein the at least one company data indicates at least one company to perform the stock valuation; and
transmitting a valuation ratio data to the at least one user device; and
a processing device communicatively coupled with the communication device, wherein the processing device is configured for:
obtaining at least one financial statement of the at least one company from at least one first external source based on the at least one company data;
extracting at least one financial metric of the at least one company from the at least one financial statement;
generating a stock fair value data based on the at least one financial metric, wherein the stock fair value data comprises an estimated fair value of at least one stock of the at least one company;
obtaining a stock data from at least one second external source, wherein the stock data comprises an actual price value of the at least one stock of the at least one company; and
generating the valuation ratio data based on the stock fair value data and the stock data, wherein the valuation ratio data comprises a valuation ratio of the at least one stock.

12. The system of claim 11, wherein the processing device is configured for:
generating a company fair value data based on the at least one financial metric, wherein the company fair value data comprises an estimated fair value of the at least one company; and
obtaining a share data of the at least one company from the at least one second external source, wherein the share data indicates a total number of shares of the at least one company, wherein the generating of the stock fair value data is further based on each of the company fair value data and the share data.

13. The method of claim 12, wherein the extracting of the at least one financial metric comprises:
extracting at least one asset metric of the at least one company based on the at least one financial statement;
extracting at least one present earning metric of the at least one company based on the at least one financial statement; and
estimating at least one future earning metric of the at least one company based on the at least one financial statement, wherein the generating of the company fair value data is based on the extracting of the at least one asset metric, the extracting of the at least one present earning metric, and the estimating of the at least one future earning metric of the at least one company, wherein the generating of the company fair value data comprises generating the estimated fair value of the at least one company using the at least one asset metric, the at least one present earning metric, and the at least one future earning metric.

14. The system of claim 13, wherein the extracting of the at least one financial metric further comprises:
computing a Net Tangible Asset to Price Ratio (NTPR) using the at least one asset metric of the at least one company;
computing a Discounted Earnings to Price Ratio (DEPR) by extrapolating at least one of the at least one present earning metric of the at least one company and the at least one future earning metric of the at least one company; and
computing a Discounted Terminal Earnings to Price Ratio (DTPR) using the DEPR and at least one model parameter, wherein the at least one model parameter comprises at least one of a terminal multiplier and a number of years for a growth phase, wherein the generating of the stock fair value data is based on the computing of the NTPR, the computing of the DEPR, and the computing of the DTPR.

15. The system of claim 12, wherein the at least one financial metric comprises a Net Tangible Asset to Price Ratio (NTPR), a Discounted Earnings to Price Ratio (DEPR), and a Discounted Terminal Earnings to Price Ratio (DTPR), wherein the generating of the company fair value data comprises:
computing a sum of the NTPR, the DEPR, and the DTPR of the at least one company; and
obtaining the estimated fair value of the at least one company based on the computing of the sum, wherein the generating of the at least one stock fair value data is based on the obtaining of the estimated fair value of the at least one company.

16. The system of claim 11, wherein the generating of the stock fair value data comprises generating the stock fair value data based on the at least one financial metric using at least one model parameter, wherein the at least one model parameter is dynamically updated.

17. The system of claim 11 wherein the communication device is further configured for receiving an input data from the at least one user device, wherein the processing device is further configured for:
updating, using the processing device, the at least one financial metric based on the input data; and
obtaining, using the processing device, at least one updated financial metric based on the updating of the at least one financial metric, wherein the generating of the stock fair value data is further based on the at least one updated financial metric.

18. The system of claim 16, wherein the processing device is further configured for:
obtaining a plurality of financial statements of a plurality of indicator companies from the at least one external source;
extracting a plurality of financial metrics of the plurality of indicator companies from the plurality of financial statements;
generating a plurality of estimated fair values of a plurality of stocks of the plurality of indicator companies based on the plurality of financial metrics;
obtaining a plurality of stock data from the at least one second external source, wherein the plurality of stock data comprises a plurality of actual price values of the plurality of stocks of the plurality of indicator companies; and
adjusting the at least one model parameter based on the plurality of estimated fair values of the plurality of stocks and the plurality of actual price values of the plurality of stocks, wherein the generating of the stock fair value data is further based on the adjusting of the at least one model parameter.

19. The system of claim 18, wherein the processing device is further configured for:
generating a plurality of valuation ratio data based on the plurality of estimated fair values and the plurality of stock data, wherein the plurality of valuation ratio data comprises a plurality of valuation ratios of the plurality of stocks; and
computing a plurality of logarithmic valuation ratios of the plurality of stocks using the plurality of valuation ratios, wherein the adjusting of the at least one model parameter is further based on the computing of the plurality of logarithmic valuation ratios of the plurality of stocks.

20. The system of claim 11, wherein the communication device is further configured for:
receiving at least one indicator data from the at least one user device, wherein the at least one indicator data indicates a user preference on at least one of at least one financial indicator for computing a Screener Figure of Merit (SFOM) and a weight of the at least one financial indicator in the SFOM; and
transmitting a SFOM data to the at least one user device, wherein the at least one user buys the at least one stock based on the SFOM of the at least one stock, wherein the processing device is configured for generating the Screener Figure of Metric (SFOM) data of the at least one stock based on the at least one indicator data, wherein the SFOM data of the at least one stock comprises the SFOM of the at least one stock.
